(19) United States
(12) Patent Application Publication
(10) Pub. No.: US 2020/0210524 A1
(43) Pub. Date: Jul. 2, 2020

(54) ANALYTICAL PROCESSING SYSTEM SUPPORTING NATURAL LANGUAGE ANALYTIC QUESTIONS

(71) Applicant: Microsoft Technology Licensing, LLC, Redmond, WA (US)

(72) Inventors: Jaewon Yang, Campbell, CA (US); Maneesh Varshney, Milpitas, CA (US); Mikhail Obukhov, Fremont, CA (US); Sung Yoon, Berkeley, CA (US)

(21) Appl. No.: 16/235,916

(22) Filed: Dec. 28, 2018

(51) Int. Cl. G06F 17/27; G06F 16/28; G06F 16/33; G06F 16/332; G06N 20/20

(52) U.S. Cl. CPC G06F 17/2785; G06F 16/283; G06N 20/20; G06F 16/3329; G06F 16/3344

(57) ABSTRACT

Online analytical processing system supporting natural language analytic questions. In one embodiments, for example, a computer-implemented method includes: receiving a natural language question; determining an intent of the natural language question; based on the intent of the natural language question, predicting a metric query language statement based on the natural language question; translating the metric query language statement to a structured query language statement; causing an execution of the structured query language statement against multidimensional database data; and providing an answer to the natural language question based on a result of the execution of the structured query language statement against the multidimensional database data.

### TECHNICAL FIELD

The disclosed implementations relate generally to online analytical processing (OLAP) computer systems including, but not limited to, natural language interfaces to such systems.

### BACKGROUND

A vast amount of the world's digital information is stored in structured database systems such as, for example, relational database systems. Asking questions of and getting answers from this information (i.e., querying) typically requires expertise with a structured database query language such as, for example, the Structured Query Language (SQL). In addition, domain-specific knowledge of the structure (schema) of the information in the structured database such as the names of the tables and columns containing the information of interest is required in order to formulate a proper structured database query language statement.

As the amount of information stored in structured database systems continues to grow, the number of users that desire to query the information grows with it. Many of these users including data analysts and business intelligence analysts are not experts in—and do not desire to be experts in—structured database systems or structured database query languages. Theoretically, natural language interfaces to structured database systems could be developed that allow users to query information stored in structured database systems more naturally using a natural language query language by which users can pose questions of the information without having expertise in a structured database query language.

Constructing Structured Query Language (SQL) statements from natural language questions has been studied in the past. Early efforts centered on constructing SQL statements for semantically tractable questions using a max-flow graph match approach. A limitation of the max-flow graph match approach is its deficiency in answering non-semantically tractable natural language questions such as natural language questions containing words that are absent from a predetermined lexicon.

More recently, machine learning neural network-based approaches have been proposed. With these approaches, natural language questions and SQL statements are treated as sequences and a sequence-to-sequence model is trained and used as a parser. One issue with these approaches is that different SQL statements may be equivalent to each other due to commutativity and associativity. As a result, the order of constraints in the predicate clause (e.g., WHERE clause of SQL statements) can negatively affect the performance of sequence-to-sequence models because determining an optimal ordering of constraints is difficult. One approach to mitigate this ordering issue is to employ reinforcement learning into the sequence-to-sequence model. Other possible mitigation approaches include using a SQL sketch-based approach that employs a sequence-to-set model. Unfortunately, SQL sketch-based approaches typically suffer from the limitation that only very basic SQL statements can be constructed such as, for example, SQL statements of the form SELECT-FROM-WHERE.

Computer-implemented techniques disclosed herein address these and other issues.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### SUMMARY

The appended claims may serve as a useful summary of some implementations of the present invention.

### BRIEF DESCRIPTION OF THE DRAWINGS

For a better understanding of the various described implementations, reference should be made to the Description of Implementations below, in conjunction with the following drawings in which like reference numerals refer to corresponding parts throughout the figures.

FIG. 1 illustrates an example computer system in accordance with some implementations.

FIG. 2 illustrates an example natural language interface system, in accordance with some implementations.

FIG. 3 illustrates a slot prediction task, in accordance with some implementations.

FIG. 4 is a flowchart of a high-level approach for slot prediction, in accordance with some implementations.

FIG. 5 illustrates an approach for training a metric model, in accordance with some implementations.

FIG. 6 illustrates an approach for training a breakdown model, in accordance with some implementations.

FIG. 7 illustrates an approach for training a filter model, in accordance with some implementations.

FIG. 8A-8D illustrate example system architectures in accordance with some implementations.

FIG. 9A-9B illustrate example multidimensional database data schemas in accordance with some implementations.

FIG. 10 is a flowchart of a process for metric-centric transformations of multidimensional database data, according to some implementations.

FIG. 11 is a flowchart of a process for online analytic processing supporting natural language analytic questions, according to some implementations.

FIG. 12 is a flowchart of a process for predicting query language statements from natural language questions, according to some implementations.

### DETAILED DESCRIPTION

This disclosure provides example data processing systems and methods providing support for answering natural language analytic questions of multidimensional database data.

Reference will now be made in detail to implementations, examples of which are illustrated in the accompanying drawings. In the following detailed description, numerous specific details are set forth in order to provide a thorough understanding of the various described implementations. However, it will be apparent to one of ordinary skill in the art that the various described implementations may be practiced without these specific details. In other instances, well-known methods, procedures, components, circuits, and networks have not been described in detail so as not to unnecessarily obscure aspects of the implementations.

### General Overview

It is a technical challenge to implement a computer system capable of correctly understanding and answering natural language analytic questions about multidimensional database data stored in a structured database system such as a relational database system.

In some implementations, a technical solution to this technical challenge is provided by predicting an intermediate metric query language statement (MQL statement) from a natural language analytic question (NL analytic question) and translating the intermediate MQL statement to a structured query language statement (SQL statement) instead of directly predicting a SQL statement from the NL analytic question.

By predicting the intermediate MQL statement from the NL analytic question instead of predicting the SQL statement directly from the NL analytic question, some beneficial technical effects are realized. First, the prediction task is simplified to predicting up to at most four different aspects of an MQL statement from a NL analytic question. The four different aspects of a MQL statement that can be predicted from a NL analytic question are discussed in greater detail below and are: (1) metric, (2) breakdown, (3) filter, and (4) time. Relatedly, due to the more general-purpose nature of SQL compared to MQL, the prediction task is simplified because predicting a valid MQL statement from a NL analytic question does not require the extent of enforcement of local constraints on the multidimensional database data that would be required if a SQL statement were to be predicted directly from the NL analytic question.

### Example Computer System

Some implementations encompass performance of a method by a computing system having one or more processors and storage media. The one or more processors and the storage media may be provided by one or more computer systems. The storage media of the computing system may store one or more computer programs that include instructions configured to perform the method and that are executed by the one or more processors to perform the method.

For an implementation that encompasses multiple computer systems, the computer systems may be arranged in a distributed, parallel, clustered or other suitable multi-node computing configuration in which computer systems are continuously, periodically, or intermittently interconnected by one or more data communications networks (e.g., one or more internet protocol (IP) networks.) Further, it need not be the case that the set of computer systems that execute the instructions be the same set of computer systems that provide the storage media storing the one or more computer programs, and the sets may only partially overlap or may be mutually exclusive.

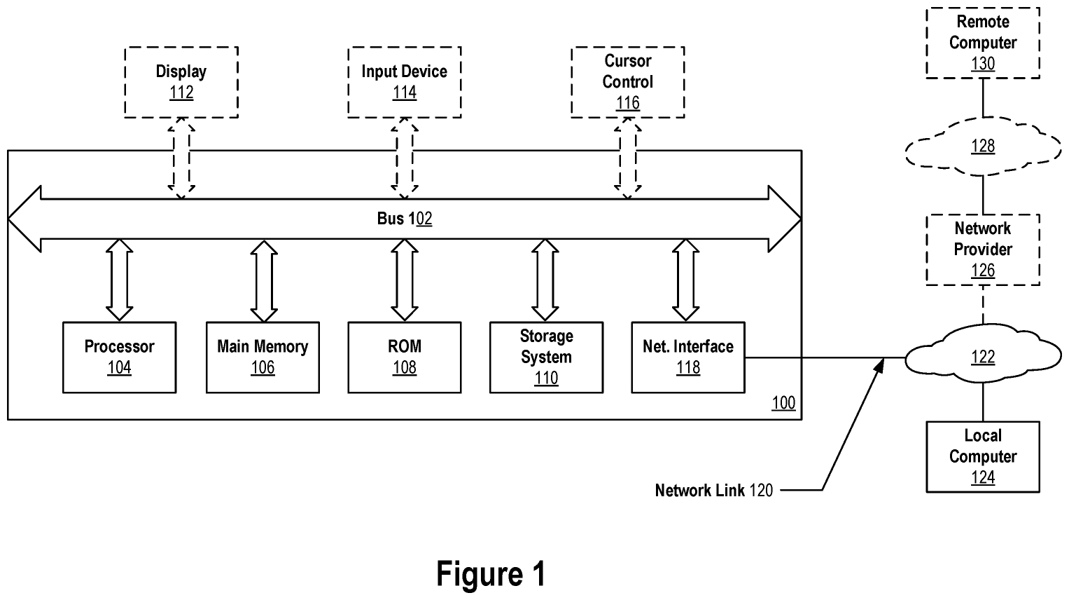

FIG. 1 is a block diagram of an example computer system 100 in accordance with some implementations. Computer system 100 includes bus 102 or other communication mechanism for communicating information, and one or more hardware processors coupled with bus 102 for processing information. Hardware processor 104 may be, for example, a general-purpose microprocessor, a central processing unit (CPU) or a core thereof, a graphics processing unit (GPU), or a system on a chip (SoC).

Computer system 100 also includes a main memory 106, typically implemented by one or more volatile memory devices, coupled to bus 102 for storing information and instructions to be executed by processor 104. Main memory 106 also may be used for storing temporary variables or other intermediate information during execution of instructions by processor 104. Computer system 100 may also include read-only memory (ROM) 108 or other static storage device coupled to bus 102 for storing static information and instructions for processor 104. A storage system 110, typically implemented by one or more non-volatile memory devices, is provided and coupled to bus 102 for storing information and instructions.

Computer system 100 may be coupled via bus 102 to display 112, such as a liquid crystal display (LCD), a light emitting diode (LED) display, or a cathode ray tube (CRT), for displaying information to a computer user. Display 112 may be combined with a touch sensitive surface to form a touch screen display. The touch sensitive surface is an input device for communicating information including direction information and command selections to processor 104 and for controlling cursor movement on display 112 via touch input directed to the touch sensitive surface such by tactile or haptic contact with the touch sensitive surface by a user's finger, fingers, or hand or by a hand-held stylus or pen. The touch sensitive surface may be implemented using a variety of different touch detection and location technologies including, for example, resistive, capacitive, surface acoustical wave (SAW) or infrared technology.

Input device 114, including alphanumeric and other keys, may be coupled to bus 102 for communicating information and command selections to processor 104.

Another type of user input device may be cursor control 116, such as a mouse, a trackball, or cursor direction keys for communicating direction information and command selections to processor 104 and for controlling cursor movement on display 112. This input device typically has two degrees of freedom in two axes, a first axis (e.g., x) and a second axis (e.g., y), that allows the device to specify positions in a plane.

Instructions, when stored in non-transitory storage media accessible to processor 104, such as, for example, main memory 106 or storage system 110, render computer system 100 into a special-purpose machine that is customized to perform the operations specified in the instructions. Alternatively, customized hard-wired logic, one or more ASICs or FPGAs, firmware and/or hardware logic which in combination with the computer system causes or programs computer system 100 to be a special-purpose machine.

A computer-implemented process may be performed by computer system 100 in response to processor 104 executing one or more sequences of one or more instructions contained in main memory 106. Such instructions may be read into main memory 106 from another storage medium, such as storage system 110. Execution of the sequences of instructions contained in main memory 106 causes processor 104 to perform the process. Alternatively, hard-wired circuitry may be used in place of or in combination with software instructions to perform the process.

The term “storage media” as used herein refers to any non-transitory media that store data and/or instructions that cause a machine to operate in a specific fashion. Such storage media may comprise non-volatile media (e.g., storage system 110) and/or volatile media (e.g., main memory 106). Non-volatile media includes, for example, read-only memory (e.g., EEPROM), flash memory (e.g., solid-state drives), magnetic storage devices (e.g., hard disk drives), and optical discs (e.g., CD-ROM). Volatile media includes, for example, random-access memory devices, dynamic random-access memory devices (e.g., DRAM) and static random-access memory devices (e.g., SRAM).

Storage media is distinct from but may be used in conjunction with transmission media. Transmission media participates in transferring information between storage media. For example, transmission media includes coaxial cables, copper wire and fiber optics, including the circuitry that comprise bus ˜02. Transmission media can also take the form of acoustic or light waves, such as those generated during radio-wave and infra-red data communications.

Computer system 100 also includes a network interface 118 coupled to bus 102. Network interface 118 provides a two-way data communication coupling to a wired or wireless network link 120 that is connected to a local, cellular or mobile network 122. For example, communication interface 118 may be IEEE 802.3 wired “ethernet” card, an IEEE 802.11 wireless local area network (WLAN) card, a IEEE 802.15 wireless personal area network (e.g., Bluetooth) card or a cellular network (e.g., GSM, LTE, etc.) card to provide a data communication connection to a compatible wired or wireless network. In any such implementation, communication interface 118 sends and receives electrical, electromagnetic or optical signals that carry digital data streams representing various types of information.

Network link 120 typically provides data communication through one or more networks to other data devices. For example, network link 120 may provide a connection through network 122 to local computer system 124 that is also connected to network 122 or to data communication equipment operated by a network access provider 126 such as, for example, an internet service provider or a cellular network provider. Network access provider 126 in turn provides data communication connectivity to another data communications network 128 (e.g., the internet). Networks 122 and 128 both use electrical, electromagnetic or optical signals that carry digital data streams. The signals through the various networks and the signals on network link 120 and through communication interface 118, which carry the digital data to and from computer system 100, are example forms of transmission media.

Computer system 100 can send messages and receive data, including program code, through the networks 122 and 128, network link 120 and communication interface 118. In the internet example, a remote computer system 130 might transmit a requested code for an application program through network 128, network 122 and communication interface 118. The received code may be executed by processor 104 as it is received, and/or stored in storage device 910, or other non-volatile storage for later execution.

### Example Natural Language Interface System

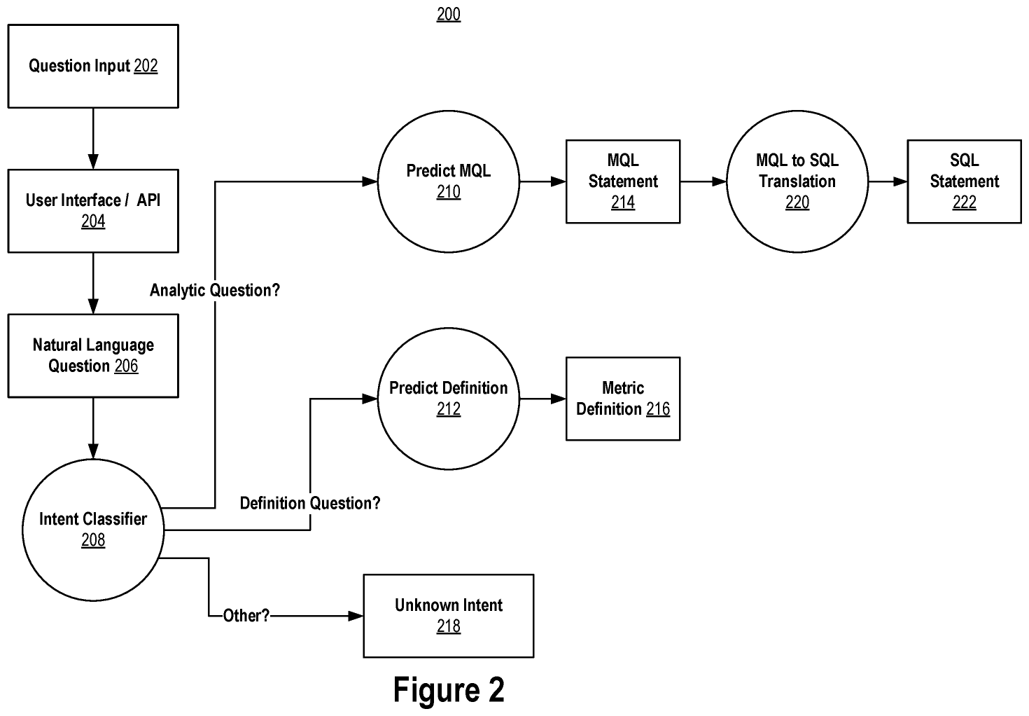

FIG. 2 illustrates an example natural language interface system 200, according to some implementations. The system 200 may include a user interface/application programming interface (API) 204 for receiving a question input 202. From the question input 202, the user interface/API 204 may output a natural language question 206 which may then be input to an intent classification system (intent classifier) 208.

The intent classifier 208 may input the natural language question 206 to an MQL statement prediction system (MQL predictor) 210 or a metric definition prediction system (definition predictor) 212 depending on whether the intent classifier 208 determines the natural language question 206 to be a natural language analytic question or a natural language metric definition question. If the intent classifier 208 does not determine the natural language question 206 to be either a NL analytic question or a NL metric definition question, then the intent classifier 208 may judge the intent of the natural language question 206 to be unknown 218 or having other intent. If the intent classifier 208 judges the natural language question 206 to be a NL analytic question, then the MQL predictor 210 attempts to predict a MQL statement 214 from the NL analytic question. If the intent classifier 208 judges the natural language question 206 to be a NL metric definition question, then the definition predictor 212 attempts to predict a metric definition 216 from the NL metric definition question.

Some non-limiting examples of a NL metric definition question are: “What is active community?” and “What is the definition of 4×4?” With a NL metric definition question, the intent is to obtain an answer that provides a definition of a particular domain-specific metric. A non-limiting example of a NL analytic question is: “How many active contributors last week?” With a NL analytic question, the intent is to obtain an answer that provides a particular domain-specific metric itself. In some implementations, metrics are specific to the domain of the multidimensional database data being analyzed. For example, the metrics specific to a large-scale online social networking domain may answer such NL analytic questions as: “What are the top 5 countries by the number of contributors?” or “How many contributors are from like, share, message in the last 7 days?” As another example, the metrics specific to a data warehouse storing sales data for products and stores may answer NL analytic questions such as: “Which store sold the most in Q4 of 2017?”

An MQL statement 214 predicted from an analytic question may be translated by an MQL to SQL translation system (MQL to SQL translator) 220 to a SQL statement 222 which is then executed against multidimensional database data by a database management system capable of executing the SQL statement 222. The result of the SQL statement 222 execution may then be provided in an answer to the natural language question 206. The answer may be provided to a user in the user interface 204 or to another system via the API 204, depending on whether the question input 202 was received via the user interface 204 or received via the API 204, respectively.

Returning to the top of natural language interface system 200, the question input 202 may be provided by user input to the user interface 204 or may be provided by via the API 1204. If the question input 202 is provided by user input, the user input may take a variety of forms including, for example, user input that enters a sequence of text characters via a character input device such as, for example, a keyboard; user input that selects a question displayed in a graphical user interface such as, for example, via a pointing device (e.g., a mouse) or via a touch sensitive surface (e.g., a touchscreen); or audible user input that is spoken by a user to a microphone (e.g., a microphone of a personal digital assistant).

If the question input 202 is provided via the API 204, the API 204 may be invoke-able by another computing system over a data network (e.g., an Internet Protocol-based network) according to an application-level data interchange format (e.g., eXtensible Markup Language (XML), JavaScript Object Notation (JSON), etc.) in which the question input 202 may be formatted in the invocation. There is no requirement, however, that the API 204 be invoke-able by a network peer computing system over a data network and the API 204 may be a programmatic API configured for intra-process communication instead. Further, there is no requirement that system 200 include both the user interface 204 and the API 204 and the system 100 may include just one or the other according to the requirements of the particular implementation at hand.

Regardless of whether the question input 202 is provided via the user interface 204 or via the API 204, the question input 202 may be used as the natural language question 206 or may be transformed to the natural language question 206. The natural language question 206 may be represented as text (i.e., a sequence of one or more characters). For example, if the question input 202 is audibly spoken by a user, then the natural language question 206 may be the output of a speech-to-text process given the question input 202 as input. As another example, the question input 202 may already be in text form and may be used directly as the natural language question 206, or the natural language question 206 may represent the result of textual pre-processing performed on the text-based question input 202 (e.g., spelling and/or grammar correction).

### Intent Classification

In some implementations, the intent classifier 208 is based on supervised machine learning. The training corpus may be composed of representative natural language questions (training examples) and corresponding labels. The label for a training example may indicate whether training example is an analytic question, a metric definition question, or other type of question. The training corpus may contain a mix of natural language questions labeled analytic questions and natural language questions labeled metric definition questions. In some non-limiting implementations, the number of training examples in the training corpus is approximately two thousand (2,000), but can be more or less according to the requirements of the particular implementation at hand.

For training the classifier model based on the set of training examples, various different feature selection approaches may be used. For example, N-gram groups of varying lengths at the character and world level may be selected from the training examples as features. Words of the training examples may be stemmed and/or lemmatized as a pre-processing step before N-gram groups are selected. The frequency count and/or TF-IDF score for the selected features may be extracted and used to train the classifier model. When training, the range of the N-gram groups can be adjusted until the prediction accuracy ceases to increase. For example, the classifier model may be trained based on character-level N-grams ranging between 1 and 7 characters extracted using frequency count or TF-IDF. As another example, the classifier model may be trained based on word-level N-grams ranging between 1 (unigram) and 2 (bigram) words extracted using frequency count or TF-IDF.

Accuracy of a trained classifier model may be measured in terms of precision and recall for predictions made based on the trained model for a set of test training examples. The set of test training examples may include a mix of known analytic questions and known metric definition questions. In some implementations, the trained model is deemed sufficiently accurate if the precision and recall rate for the analytic questions in the set of test training examples is at least 95%. In some implementations, a bias term of the trained model is adjusted to increase recall of the metric definition questions in the set of test training examples at the expense of precision,

Different types of classifier models may be used for the intent classifier 208. For example, a support vector machine classifier or a multinomial Naive Bayes classifier may be used. For example, a support vector machine classifier with fixed parameters may be used such as, for example, a support vector machine classifier with a linear kernel, a constant slack variable (e.g., equal to one (1)), a square-hinge loss function, and L2 loss penalty. Alternatively, a multinomial Naïve Bayes classifier with fixed parameters may be used such as, for example, a multinomial Naïve Bayes with a constant Laplace smoothing parameter (e.g., equal to one (1)). As yet another alternative, a linear regression classifier may be used.

While a support vector machine classifier, a multinomial Naïve Bayes classifier, or a linear regression classifier may be used in the intent classifier 208, it is also possible to use a neural network classifier. For example, convolutional neural network text classifier or a recurrent neural network text classifier may be used.

### MQL Predictor

If the intent classifier 208 judges the natural language question 206 to be an analytic question, then the natural language analytic question 206 may then be provided as input to the MQL predictor 210 to predict a MQL statement 214 from the natural language analytic question 206. The metric query language, or MQL, is described in greater detail below. However, in general, the task of the MQL predictor 210 is to predict the values of “slots” of a MQL statement template based on the natural language analytic question and metadata about the predefined possible domain-specific slot values.

In some implementations, a MQL statement template has up to four different types of slots: a metric slot, a breakdown slot, a filter slot, and a time slot. The metric slot, the breakdown slot, and filter slot each have a corresponding set of predefined possible domain-specific slot values. The sets of predefined possible slot values are derived based on the domain of the multidimensional database data (e.g., contributions by members of a social network vs sales data for products and stores) and the expected types of questions that will be asked of the data. For example, the set of possible slot values for the metric slot may be the names of all domain-specific metrics that are query-able from the multidimensional database data using an appropriately formed MQL statement. Similarly, for the sets of possible slot values for the breakdown slot and the filter slot. For example, the natural language analytic question might be: “How many contributors are from like, share, message in the last 7 days?” Here, the natural language analytic question pertains to the domain of an online social network. The question is asking, for each of the like, share, and message types of contributions to the online social network, how many contributors were there of that type to the online social network in the past seven days? Here, a like contribution may involve a user action such as selecting a graphical user interface element that indicates a favorable sentiment for particular online social network content such as a post, a photo, or a comment by another member of the social network, or the equivalent. A share contribution may involve a user action that makes particular content (e.g., a selected file) available to another user though the online social network, or the equivalent. A message contribution may involve a user action that cause the online social network to send a text or multimedia message to another user through the online social network, or the equivalent.

For example, the MQL statement predicted by the MQL predictor 210 for answering this question could be: “METRIC_members_in_active_community BREAKDOWN DIM contribution_type FILTER contribution_type in (‘like’, ‘share’, ‘message’) TIME last 7 days;” Here, the keywords “METRIC,” “BREAKDOWN DIM,” “FILTER,” and “TIME” are static keywords in the MQL statement template. Each of these keywords is followed by a respective slot in the template. In particular, the values “members_in_active_community,” “contribution_type,” “contribution_type in (‘like’, ‘share’, ‘message’),” and “TIME last 7 days,” are predicted by the MQL predictor 210 for the metric slot, the breakdown slot, the filter slot, and the time slot, respectively. Each of those slot values are one of the possible predefined slot values for the corresponding slot. For example, the slot value “members_in_active_community” may be one of the possible domain-specific slot values in the set of predefined possible slot values for the metric slot. The final MQL statement may be formed by the MQL predictor 210 by combining the predicted values for the slots with the MQL statement template to produce a MQL statement that contains the static keywords of the MQL statement template and the predicted slot values in their corresponding slots.

It should be noted that the MQL predictor 210 may not predict any value for one or more of the slots in the MQL statement template depending on the natural language analytic question at hand. For example, the MQL predictor 210 may not predict a value for the time slot for the natural language analytic question: “How many contributors in the past 7 days?” As such, it is not necessary that the MQL predictor 210 predict a value for all four of the slots.

### High-Level Slot Prediction Approach

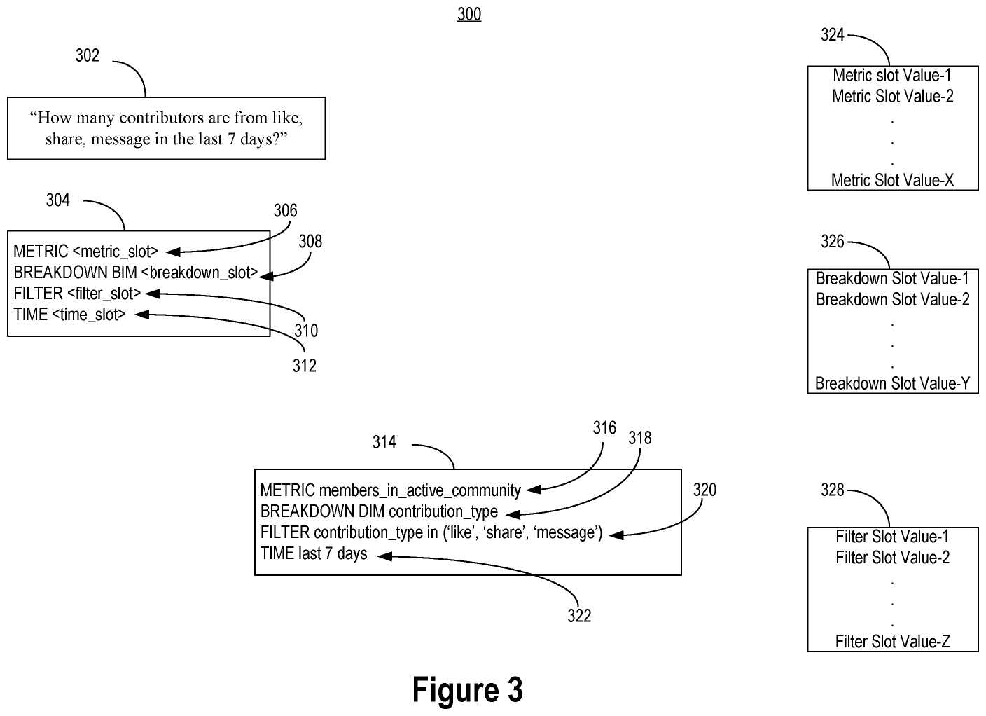

FIG. 3 illustrates the prediction task at a high-level by example, according to some implementations. Given an input natural language analytic question (e.g., 302) and a MQL statement template (e.g., 304) with a metric slot 306, a breakdown slot 308, a filter slot 310, and a time slot 312, the task the MQL predictor 210 is to predicate a MQL statement (e.g., 314) that represents the input natural language question (e.g., 302) in MQL. More particularly, the task of the MQL predictor 210 is to predict a value (e.g., 316) for the metric slot (e.g., 306) from the input natural language analytic question (e.g., 302), predict a value (e.g., 318) for the breakdown slot (e.g., 308) from the input natural language analytic question (e.g., 302), predict a value (e.g., 320) for the filter slot (e.g., 310) from the input natural language analytic question (e.g., 302), and predict a value (e.g., 322) for the time slot (e.g., 312) from the input natural language analytic question (e.g., 302). The value (e.g., 316) predicted for the metric slot (e.g., 306) from the input natural language analytic question (e.g., 302) is one of the predefined possible values 324 for the metric slot (e.g., 306), the value (e.g., 318) predicted for the breakdown slot (e.g., 308) from the input natural language analytic question (e.g., 302) is one of the predefined possible values 326 for the breakdown slot (e.g., 308), and the value (e.g., 320) predicted for the filter slot (e.g., 310) from the input natural language analytic question (e.g., 302) is one of the predefined possible values 328 for the filter slot (e.g., 310). As mentioned above, the value (e.g., 322) predicated for the time slot (e.g., 312) from the input natural language analytic question (e.g., 302) may obtained according time value prediction approach described in greater detail below.

As mentioned above, the predefined possible values 324, 326, and 328 may depend on the domain and structure of the underlying multidimensional database data. For example, the following table lists some non-limiting example predefined possible values for the metric slot in a domain pertaining to online contributions to a social network and an associated description of the metric represented by the corresponding value:

| Value | Description |
|---|---|
| homepage_sessions | Number of homepage touching |
| | sessions as defined by product |
| | page key group (Number of |
| | sessions where users, during |
| | some point of the session, |
| | navigate to a page that is |
| | in the “home page” group |
| | of pages)? |
| email_sends | Number of email sends |
| unique_contributors | Number of unique contributors. |
| email_complain_three_day | Number of complaints within 3 |
| | days of the email send |

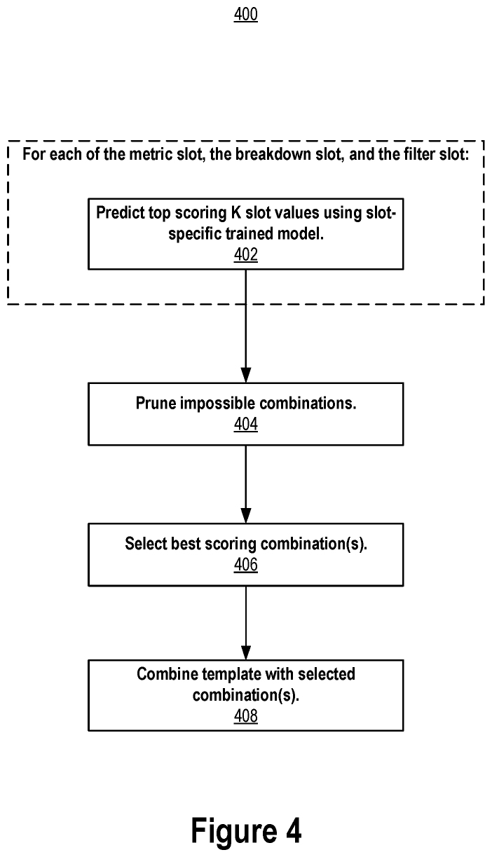

FIG. 4 is a flowchart 400 of a high-level approach performed by the MQL predictor 410 for predicting values for the metric slot, the breakdown slot, and the filter slot based on an input natural language analytic question, according to some implementations. In some implementations, predicting values of the time slot based on the input target natural language analytic question is based on the SUTime library or similar library configured to recognize and normalize natural language time expressions. More information the SUTime library is currently available on the Internet at/software/sutime.html in the nlp.stanford.edu domain. Alternatively, the Spacy library may be used. More information on the Spacy library is available on the Internet in the spacy.io domain.

The approach begins by predicting (402) a top scoring K number of the predefined possible slot values for each of the metric slot, the breakdown slot, and the filter slot. In some implementations, K is three but K may be more or less according to the requirements of the particular implementation at hand. A separate machine learning model is trained for each of the metric slot, the breakdown slot, and the filter slot.

In some implementations, slot values for a target slot are predicted using the respective trained model. For example, slot values for the metric slot are predicted using the model trained for predicting metric slot values, and likewise for the breakdown slot and the filter slot. For ease of understanding, the respective slot models may be referred to hereinafter as the “metric slot” model, the “breakdown slot” model, and the “filter slot” model. Each model may be trained based on the respective set of predefined possible domain-specific slot values. In particular, the metric slot model may be trained based on the predefined possible slot values for the metric slot, the breakdown slot model may be trained based on the predefined possible slot values for the breakdown slot, and the filter model may be trained based on the predefined possible slot values for the filter slot.

As a result of the predicting 402, there may be up to K to the power of 3 number of combinations of one predicted metric slot value, one predicted breakdown slot value, and one predicted filter slot value, assuming at least K values are predicated for each the three slot types. Of these combinations, impossible ones may be pruned/discarded 304. For example, predicted combinations where it is known that a predicted metric slot value of the combination cannot be validly combined in a valid MQL statement with a predicated breakdown slot value of the combination may be pruned/discarded from further consideration. One possible example of such an invalid combination might be a predicted metric where it is not possible to breakdown the metric by a predicted dimension according to the structure of the underlying multidimensional database data. For example, the measures of the multidimensional database data for the predicted metric may not have attribute/field/foreign key reference to the dimension corresponding to the predicted breakdown slot value. For purposes of pruning/discarded invalid combinations, the MQL predictor 210 may maintain a dictionary having pairs or tuples of incompatible slot values. The MQL predictor 210 may prune/discard a combination if the combination contains a pair or tuple of incompatible slot values according to the dictionary.

The remaining combinations after impossible combinations are pruned/discarded 404 are considered. The top scoring combination may be selected 406 for combining 408 with the MQL statement template. Returning to a previous example, the top scoring combination may be represented by the tuple (“members_in_active_community,” “contribution_type,” “contribution_type in (‘like’, ‘share’, ‘mess age’”) where the first position in the tuple is the predicted metric slot value of the combination, the second position in the tuple is the predicted breakdown slot value of the combination, and the third position in the tuple is the predicted filter slot value of the combination. As such, this top scoring combination may be combined with a MQL statement template to produce the MQL statement “METRIC_members_in_active_community BREAKDOWN DIM contribution_type FILTER contribution_type in (‘like’, ‘share’, ‘message’).” If a time slot value is also predicted, then this may also be included in the MQL statement as in, for example, “METRIC members_in_active_community BREAKDOWN DIM contribution_type FILTER contribution_type in (‘like’, ‘share’, ‘message’) TIME last 7 days.”

### Training Approach

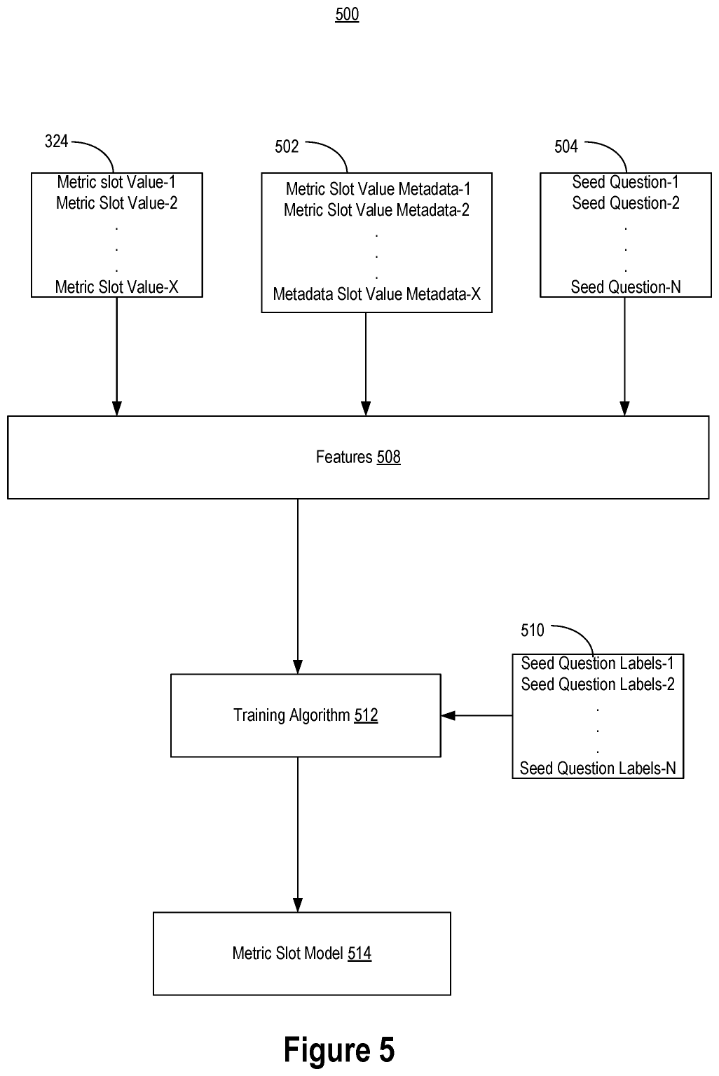

FIG. 5 illustrates an approach 500 for training a metric slot model 514, according to some implementations. Training features 508 are generated from the set of predefined possible metric slot values 324, metadata 502 about the predefined possible metric values 324, and a set of example natural language analytic questions 504, sometimes referred to herein as seed questions 504. The metadata 502 about a predefined possible metric slot value 324 may include, but is not limited to, a text description of the metric slot value and/or a name for the metric slot value.

In some implementations, the training features 508 include all of the following features, or a subset, or a superset thereof:
word embeddings vectors for words in the seed questions 504,
parts of speech tags for words in the seed questions 504,
treebank dependency tags for words in the seed questions 504,
keywords in the seed questions 504 that are also keywords in the descriptions in the metadata 502 about the predefined possible metric slot values 324,
the description in the metadata 502 about a corresponding possible metric slot value 324,
seed questions 504 that, according to the training labels 510, are about a particular metric slot value of the metric slot values 324,
the frequency counts of metric slot values 324 in the seed questions 504,
measures of average and/or maximum similarity between n-grams (e.g., words) in the seed questions 504 and n-grams (e.g., words) in the textual metadata 502;
measures of average and/or maximum similarity between parts-of-speech (e.g., nouns, proper nouns, verbs, adjectives, adverbs, etc.) in the seed questions 504 and in the textual metadata 502; and/or
measures of average and/or maximum similarities between a first or last predetermined number of words in the seed questions 504 and all of the words in the slot value descriptions of the textual metadata 502.

The above-are just some example features that may be used in training the metric model 514 and other features 508 in addition to or instead of the above listed features of the seed questions 504 and the textual metadata 502 about the predefined possible metric slot values 324 may be used to train the metric model 514 according to the requirements of the particular implementation at hand.

Based on the features 508 and the seed question labels 510, a training algorithm 512 trains the metric slot model 514 to predict, for each predefined possible metric slot value 324, a probability that a given input natural language analytic question is directed to that metric slot value. For this, the seed question labels 510 may contain a set of binary labels for each seed question 504 that specifies, for each predefined possible metric slot value 324, whether the seed question is directed to that metric slot value. For example, if there are fifty predefined possible metric slot values 324, then each seed question 504 has fifty binary labels in the seed question labels 510 that specifies, for each of the fifty-predefined possible metric slot values 324, whether the seed question is directed to the metric slot values. In some implementations, a seed question 504 is directed to at most one or only a few predefined possible metric slot value(s) 324. As such, the absence of an explicit binary label in the seed question labels 510 for a given seed question 504 and a given predefined possible metric slot value 324 may be taken as a negative label that the given seed question 504 is not directed to the given predefined possible metric slot value 324.

A multi-class classification algorithm may be used as the training algorithm 512. For example, a one-vs-all or one-vs-rest multi-class classification training strategy may be used. The training algorithm 512 may be based on a variety of different machine learning systems including, but not limited to, a neural network (e.g., a multilayer perceptron with a softmax function final layer), k-nearest neighbors, naïve Bayes, a decision tree system, or a support vector machine.

Using the training algorithm 512, the metric slot model 514 is trained to predict, a probability, for each predefined possible metric slot value 324, that a given input natural language analytic question is directed to that predefined possible metric slot value. For this, features (predictors) may be generated for given input natural language analytic question like the features 508 generated for the seed questions 504. In some implementations, a feature vector is generated for each predefined possible metric slot value 324 that combines features of the input natural language analytic questions and features of the predefined possible metric slot value for which the feature vector is generated. This results in a set of feature vectors that are input to the trained metric slot model 514 to obtain a probability, for each predefined possible metric slot value 324, that the given input natural language analytic question is directed to that predefined possible metric slot value.

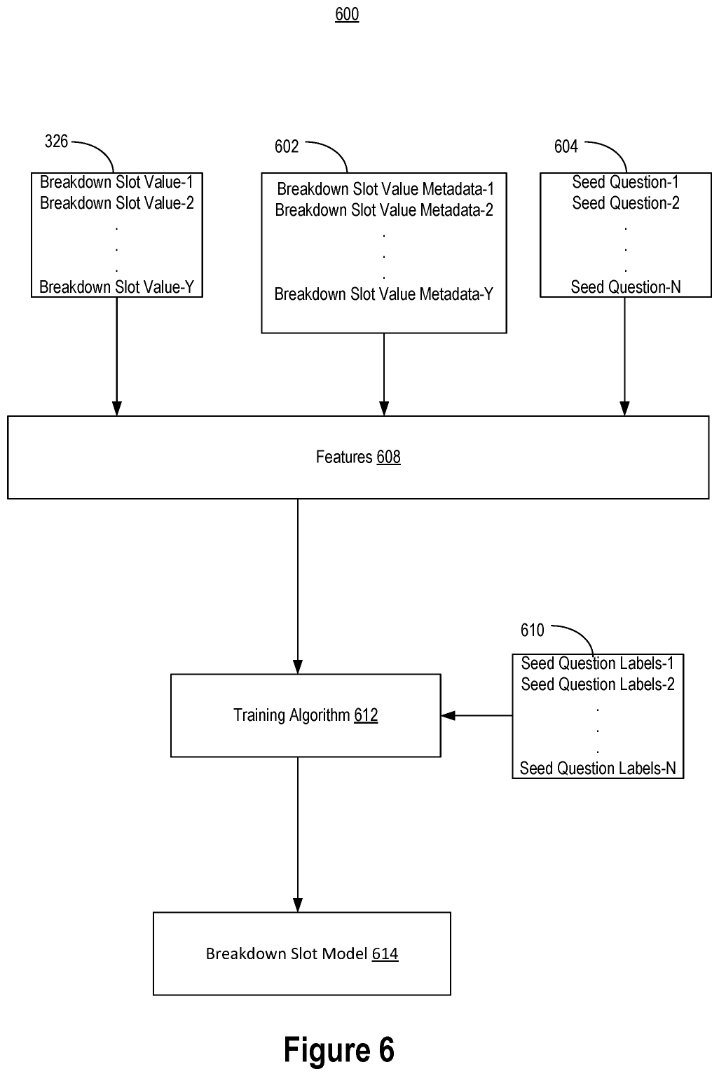

FIG. 6 illustrates an approach 600 for training a breakdown slot model 614, according to some implementations. Training features 608 are generated from the set of predefined possible breakdown slot values 326, metadata 602 about the predefined possible breakdown slot values 326, and a set of example natural language analytic questions 604, sometimes referred to herein as seed questions 604. The metadata 602 about a predefined possible breakdown slot values 326 may include, but is not limited to, a text description of the breakdown slot value and/or a name for the breakdown slot value.

In some implementations, the training features 608 include all of the following features, or a subset, or a superset thereof:
word embeddings vectors for words in the seed questions 604,
parts of speech tags for words in the seed questions 604,
treebank dependency tags for words in the seed questions 604,
keywords in the seed questions 604 that are also keywords in the descriptions in the metadata 602 about the predefined possible breakdown slot values 326,
the description in the metadata 602 about a corresponding possible breakdown slot value 326,
seed questions 604 that, according to the training labels 610, are about a particular breakdown slot value of the breakdown slot values 326,
the frequency counts of breakdown slot values 326 in the seed questions 604,
measures of average and/or maximum similarity between n-grams (e.g., words) in the seed questions 604 and n-grams (e.g., words) in the textual metadata 602;
measures of average and/or maximum similarity between parts-of-speech (e.g., nouns, proper nouns, verbs, adjectives, adverbs, etc.) in the seed questions 604 and in the textual metadata 602; and/or
measures of average and/or maximum similarities between a first or last predetermined number of words in the seed questions 604 and all of the words in the slot value descriptions of the textual metadata 602.

The above-are just some example features that may be used in training the breakdown model 614 and other features 608 in addition to or instead of the above listed features of the seed questions 604 and the textual metadata 602 about the predefined possible breakdown slot values 326 may be used to train the breakdown model 614 according to the requirements of the particular implementation at hand.

Based on the features 608 and the seed question labels 610, a training algorithm 612 trains the breakdown slot model 614 to predict, for each predefined possible breakdown slot value 326, a probability that a given input natural language analytic question is directed to that breakdown slot value. For this, the seed question labels 610 may contain a set of binary labels for each seed question 604 that specifies, for each predefined possible breakdown slot value 326, whether the seed question is directed to that breakdown slot value.

A multi-class classification algorithm may be used as the training algorithm 612. For example, a one-vs-all or one-vs-rest multi-class classification training strategy may be used. The training algorithm 612 may be based on a variety of different machine learning systems including, but not limited to, a neural network (e.g., a multilayer perceptron with a softmax function final layer), k-nearest neighbors, naïve Bayes, a decision tree system, or a support vector machine.

Using the training algorithm 612, the breakdown slot model 614 is trained to predict, a probability, for each predefined possible breakdown slot value 326, that a given input natural language analytic question is directed to that predefined possible breakdown slot value. For this, features (predictors) may be generated for given input natural language analytic question like the features 608 generated for the seed questions 604. In some implementations, a feature vector is generated for each predefined possible breakdown slot value 326 that combines features of the input natural language analytic questions and features of the predefined possible breakdown slot value for which the feature vector is generated. This results in a set of feature vectors that are input to the trained breakdown slot model 614 to obtain a probability, for each predefined possible breakdown slot value 326, that the given input natural language analytic question is directed to that predefined possible breakdown slot value.

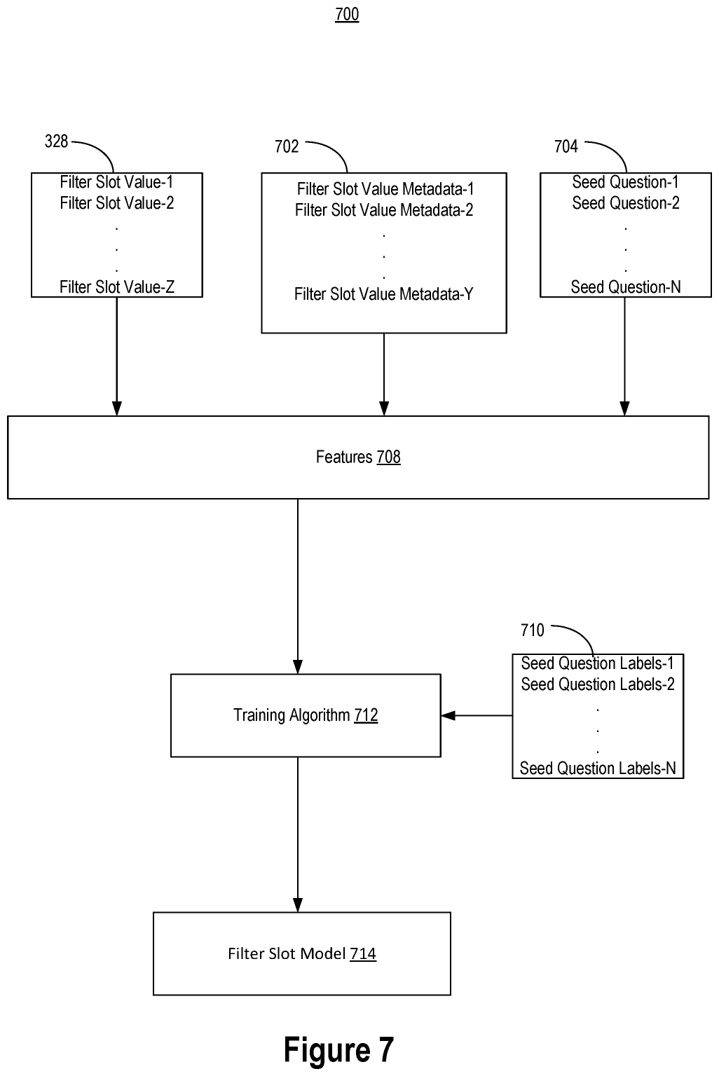

FIG. 7 illustrates an approach 700 for training a filter slot model 714, according to some implementations. Training features 708 are generated from the set of predefined possible filter slot values 328, metadata 702 about the predefined possible filter slot values 328, and a set of example natural language analytic questions 704, sometimes referred to herein as seed questions 704. The metadata 702 about a predefined possible filter slot values 328 may include, but is not limited to, a text description of the filter slot value and/or a name for the filter slot value.

In some implementations, the training features 708 include all of the following features, or a subset, or a superset thereof:
word embeddings vectors for words in the seed questions 704,
parts of speech tags for words in the seed questions 704,
treebank dependency tags for words in the seed questions 704,
keywords in the seed questions 704 that are also keywords in the descriptions in the metadata 702 about the predefined possible filter slot values 328,
the description in the metadata 702 about a corresponding possible filter slot value 328,
seed questions 704 that, according to the training labels 710, are about a particular filter slot value of the filter slot values 328,
the frequency counts of filter slot values 328 in the seed questions 704,
measures of average and/or maximum similarity between n-grams (e.g., words) in the seed questions 704 and n-grams (e.g., words) in the textual metadata 702;
measures of average and/or maximum similarity between parts-of-speech (e.g., nouns, proper nouns, verbs, adjectives, adverbs, etc.) in the seed questions 704 and in the textual metadata 702; and/or
measures of average and/or maximum similarities between a first or last predetermined number of words in the seed questions 704 and all of the words in the slot value descriptions of the textual metadata 702.

The above-are just some example features that may be used in training the filter model 714 and other features 708 in addition to or instead of the above listed features of the seed questions 704 and the textual metadata 702 about the predefined possible filter slot values 328 may be used to train the filter model 714 according to the requirements of the particular implementation at hand.

Based on the features 708 and the seed question labels 710, a training algorithm 712 trains the filter slot model 714 to predict, for each predefined possible filter slot value 328, a probability that a given input natural language analytic question is directed to that filter slot value. For this, the seed question labels 710 may contain a set of binary labels for each seed question 704 that specifies, for each predefined possible filter slot value 328, whether the seed question is directed to that filter slot value.

A multi-class classification algorithm may be used as the training algorithm 712. For example, a one-vs-all or one-vs-rest multi-class classification training strategy may be used. The training algorithm 712 may be based on a variety of different machine learning systems including, but not limited to, a neural network (e.g., a multilayer perceptron with a softmax function final layer), k-nearest neighbors, naïve Bayes, a decision tree system, or a support vector machine.

Using the training algorithm 712, the filter slot model 714 is trained to predict, a probability, for each predefined possible filter slot value 328, that a given input natural language analytic question is directed to that predefined possible filter slot value. For this, features (predictors) may be generated for given input natural language analytic question like the features 708 generated for the seed questions 704. In some implementations, a feature vector is generated for each predefined possible filter slot value 328 that combines features of the input natural language analytic questions and features of the predefined possible filter slot value for which the feature vector is generated. This results in a set of feature vectors that are input to the trained filter slot model 714 to obtain a probability, for each predefined possible filter slot value 328, that the given input natural language analytic question is directed to that predefined possible filter slot value.

### Metric Query Language

Online analytical processing (OLAP) computer systems exist for multidimensional data analysis. Although the Structured Query Language (SQL) may be used to develop query statements for multidimensional data analysis in OLAP systems, there are a number of drawbacks associated with using a general-purpose query language such as SQL for expressing certain data transformations. For example, due to SQL's general-purpose design, a data analyst or an application developer may find it cumbersome to use SQL to express query operations on database schemas such as, for example, query operations involving joins of multiple tables. In addition, the interactive nature of OLAP may require dynamic variation in query operations and expressing all of the variants using SQL may be tedious, time consuming, and error prone. As a result, a human end-user or human application developer may need to spend significant time authoring SQL query statements directed to specific metric-centric inquiries about the data.

Accordingly, there is a need for online analytical processing with more efficient and intuitive methods for expressing transformations of multidimensional database data into metrics computed based thereon. Such systems and methods optionally complement or replace conventional techniques for online analytical processing of multidimensional data.

Due to at least the challenges described above, it is desirable to have a system and method that allow for efficient, intuitive, and human-friendly ways of expressing metric-centric queries about multidimensional database data and, at the same, provide a level of flexibility for expressing various metric-centric queries in an interactive manner. The expression techniques help to more easily formulate metric-centric queries that require aggregation operations and joins. The flexible techniques facilitate interactive analysis of multidimensional data from different perspectives including consolidating, drilling down, and slicing and dicing the data. As a result, the analysis task for the data analyst and the programming task for the application developer may be easier, more efficient, and more effective.

Thus, computing systems and methods are provided with more efficient methods for expressing transformations of multidimensional database data into metrics computed based thereon in a metric-centric manner thereby increasing the effectiveness, efficiency, and user satisfaction with such systems and methods. Such systems and methods may complement or replace conventional systems and methods for expressing transformations of multidimensional database data.

In addition, in some implementations, metric-centric transformations can be accomplished using a metric-centric query language referred to herein as “the metric query language,” or just “MQL,” for short. MQL provides a more convenient, yet still flexible, means for expressing metric-centric transformations of multidimensional database data into result metrics. The result metrics may include numerical metrics computed based on the multidimensional data such as those computed using an aggregation operation applied to the multidimensional data. Such an aggregation operation may include, but is not limited to, an average (arithmetic mean) of a set of values, a count of a set of data items, a minimum value of a set of values, a maximum value of a set of values, a medium of a set of values, a mode of a set of values, a range of a set of values, a mean ignoring null values of a set of values, a standard deviation of a set of values, a sum of a set of values, or a combination of multiple aggregation operations such as, for example, an average of minimum values of multiple sets of values, etc., or the like. For example, the MQL statement METRIC population FILTER region=‘Europe’; may represent the natural language question: “what is the total population of all countries in Europe?”, and the result metric computed based on summing the individual populations of the countries in Europe.

In addition, a result metric may also include a list of ordered values. For example, the MQL statement “METRIC population BREAKDOWN DIM country TOP 5;” may represent the natural language question: “What are the top five countries in the world by population?”, and the result metric computed based on ordering all countries in the world by their population.

In some implementations, an MQL statement may be expressed in a computer as a string of characters, which may have a character encoding representation (e.g., UTF-8) when processed programmatically as a set of bytes. As such, an application developer or other user can express an MQL statement in a familiar manner.

In some implementations, an MQL statement is composed of four types of clauses: a metric clause, a breakdown clause, a filter clause, and a time clause. In some implementations, only the metric clause is required, and the breakdown clause, the filter clause, and time clause are each optional. For example, the MQL statement “METRIC population;” may provide a numerical result metric that is the world's total population. As another example, the MQL statement “METRIC population BREAKDOWN DIM county TOP 5;” may provide an ordered value result metric that is the top 5 countries in the world by total population. As yet another example, the MQL statement “METRIC population FILTER region=‘Europe’;” may provide a numeric result metric that is the total population of all countries in Europe. As yet still another example, the MQL statement “METRIC sales TIME 7;” may provide the amount of total sales for the past seven days.

The breakdown clause, the filter clause, and time clause may be combined in an MQL statement. For example, the MQL statement “METRIC population BREAKDOWN DIM country TOP 5 FILTER region=‘Europe’;” may provide an ordered value result metric that is the top 5 countries by total population in Europe. As another example, the MQL statement “METRIC sales BREAKDOWN DIM country TIME 7;” may provide the amount of total sales for the past seven days by country. As yet another example, the MQL statement“METRIC sales BREAKDOWN DIM country FILTER region=‘Europe’ TIME 7;” may provide the amount of total sales for the past seven days by country in Europe.

Expressing a metric-centric transformation of multidimensional data may be more convenient, more intuitive, and more human friendly using MQL than using SQL or other more general-purpose query language. In particular, unlike with SQL, expression of the equivalent MQL statement may not require explicitly specifying aggregation operations or joins in the MQL statement. For example, the SQL statement equivalent to “METRIC sales amount BREAKDOWN DIM city FILTER state=‘CA’ TIME 7;” maybe“SELECT SUM(sales.amount) FROM sales, stores WHERE sales.store_id=stores.id, sales.date>=daysago(7), AND stores.state=‘CA’ GROUP BY sales.city.” By using MQL instead of SQL to express the metric-centric transformation, an express specification of an aggregation operation (e.g., “SUM(sales.amount)) and a join (e.g., “sales.store_id=stores.id”) is not needed, thereby simplifying the burden on the user.

Because explicitly expressing aggregation operations and joins is not required of an MQL statement in order to transform multidimensional database data to result metrics, MQL is more metric-centric than a more general-purpose query language such as, for example, SQL. The metric-centric nature of MQL reduces the cognitive burden on the user expressing an MQL statement and allows the user to focus more on the metric-specific aspects of inquiry at hand such as, for example, the particular metric desired, how the metric should be broken down by dimension(s), the relevant time period of the data of interest, and filter(s) to apply to select a subset of the data for inclusion in the metric computation. In contrast, with a more general-purpose query language such as SQL, the user must focus on these aspects in addition to how to form a query statement in the general-purpose query language that includes the appropriate aggregation operation and joins. As a result, MQL improves the efficiency of analyzing multidimensional database data by being more metric-centric and limiting the complexity of query statement expressions that are needed to effectively and flexibly transform multidimensional database data to metrics of interest, resulting in an improved data query language for online analytical processing computer systems.

### Metric Clause

As mentioned, in some implementations, an MQL statement includes a metric clause and optionally one or more of a breakdown clause, a filter clause, and a time clause. The metric clause may be used in an MQL statement to specify a target metric of interest. The metric clause may include the keyword “METRIC” following by an identifier (e.g. name) of the target metric may be indicated in a metric clause by its name. For example, the metric clause “METRIC population” specifies a target metric identified by the name “population.”

While in some implementations the keyword “METRIC” is used in a metric clause, another keyword is used in other implementations. Thus, an implementation is not limited to any particular keyword for specification in a metric clause. For example, the keyword “MEASURE” (or another synonym of “metric”) may be used in an implementation instead of, or as a substitute for, the keyword “METRIC.” It should also be noted that a metric clause, and more generally an MQL statement, may be case insensitive with respect to keywords used. For example, them metric clause “metric population” may be semantically equivalent to “METRIC population.”

A target metric specified in a metric clause may be conceptual and need not (but can) directly identify underlying schema elements of the database schema of the multidimensional database data that is transformed into the target metric. For example, the target metric “population” may be computed based on data stored in multiple relational database tables, none of which are named or identified in the relational database schema definition as “population” or have columns named or identified in the schema definition as “population.” Instead, the transformation, in some implementations, is accomplished using metadata for the target metric that allows the MQL statement containing to metric clause to be translated to an equivalent SQL statement that can be executed against the relational database in order to achieve the desired data transformation. As such, knowledge of the particular tables and columns of the underlying relational database schema is not needed in order to formulate an MQL statement for achieving the desired data metric-centric data transformation.

In some implementations, a metric clause may contain an arithmetic expression having target metrics as operands. The operators of the arithmetic expression may include, but is not limited to, addition (‘+’), subtraction (‘−’), division (‘/’), multiplication (‘*’), and modulo (‘%’) operators. For example, the MQL statement “METRIC population_us+population_europe” may sum the numerical target metric “population_us” and the numerical target metric “population_europe” to provide the total population in Europe and the United States.

### Breakdown Clause

A breakdown clause may be used with a metric clause in an MQL statement to specify one or more target groupings for the target metric. In some implementations, the breakdown clause includes the keyword “BREAKDOWN” and an identifier or name of a target grouping. The target grouping may a dimension of the multidimensional database data, as opposed to a measure of the multidimensional data.

For example, consider the MQL statement to obtain a result metric that a sum of the total sales for all countries in each region: “METRIC sales_country BREAKDOWN region.” For example, this example MQL statement may be translated to the following example SQL statement according to the metric metadata for the target metric: “SELECT countries.region, sum(sales.amount_sold) FROM sales JOIN countries ON sales.country_id=countries.country_id GROUP BY countries.region.” In this SQL statement, an aggregation operation (“SUM”) is applied to “amount_sold” measures per country and broken down by region to which the country belongs where the region is a dimension of the sales measures. Advantageously, as illustrated by this example, it is not necessary for the MQL statement to specify the aggregation operation or the join that is specified in the SQL statement in order to obtain a desired result metric that is broken down based on (grouped by) a selected dimension of the measures, thereby simplifying the task of formulating a metric-centric query statement in which metrics are grouped by a dimension of measures of the multidimensional data.

While in some implementations the keyword “BREAKDOWN” is used in a breakdown clause, another keyword is used in other implementations. Thus, an implementation is not limited to any particular keyword for specification in a breakdown clause. For example, the keyword “GROUPING” or a set of keywords such as, for example, “BREAKDOWN DIM” (for breakdown by dimension) may be used in an implementation instead of, or as a substitute for, the keyword “BREAKDOWN.” It should also be noted that a breakdown clause, and more generally an MQL statement, may be case insensitive with respect to keywords used. For example, the breakdown clause “breakdown subregion” may be semantically equivalent to “BREAKDOWN subregion.”

It is also possible for a breakdown clause to specify more than one dimension to achieve a breakdown of the result metric by multiple dimensions. For example, the MQL statement“METRIC sales_country BREAKDOWN region, subregion” may return a result metric based on grouping per-country sales amounts into groups where each group has countries with the same region and the same subregion and then summing the per-country sales amounts in each such group. For example, this example MQL statement may be translated to the following example SQL statement according to the metric metadata for the target metric: “SELECT countries.region, countries.subregion, sum(sales.amount_sold) FROM sales JOIN countries ON sales.country_id=countries.country_id GROUP BY countries.region, countries.subregion.” Advantageously, as illustrated by this example, it is not necessary for the MQL statement to specify the aggregation operation (“SUM”) or the join (“JOIN countries ON sales.country_id=countries.country_id”) that is specified in the SQL statement in order to obtain a desired result metric that is broken down based on (grouped by) a selected multiple dimensions (region, subregion) of the measures (per-country sales amounts), thereby simplifying the task of formulating a metric-centric query statement in which metrics are grouped by multiple dimensions of measures of the multidimensional data.

In some implementations, a breakdown clause can be used to limit the number of results returned in each grouping of an ordered result metric to a specified number. In particular, a breakdown clause may include the keyword “TOP” or the like followed by an integer ‘N’ to limit the number of results returned in each group of ordered results to the top N number of results. For example, the MQL statement “METRIC unique_contributors” BREAKDOWN country TOP 5” may return the top 5 countries by the total number of contributors to an online social network. This MQL statement may be translated into the SQL statement: “SELECT approx_distinct(contributor.id), member.country FROM contributor JOIN member ON contributor.id=member.id GROUP BY member.country ORDER BY approx_distinct(contributor.id)DESC.” It should be noted that the example SQL statement does not limit the results returned to the top 5. However, a result cursor supported by the underlying relational database management system may be used to extract the top 5 results from one or more sets of results returned by the relational database management system using the cursor without having to receive all results. Advantageously, as illustrated by this example, it is not necessary for the MQL statement to specify the join (“JOIN member ON contributor.id=member.id”) that is specified in the SQL statement in order to obtain a desired result metric that is limited to the top 5 results, thereby simplifying the task of formulating a metric-centric query statement in which metrics are limited a specified top (or bottom) number of ordered results. One skilled in the art will appreciate that a bottom number of results could be similarly implemented using “BOTTOM<N>” or the like in the breakdown clause and ordering results returned by the SQL statement in ascending order instead of in descending order.

A target dimension specified in a breakdown clause may be conceptual and need not (but can) directly identify underlying schema elements of the database schema of the multidimensional database data that is transformed into a target metric. For example, the target dimension “region” of the breakdown clause “BREAKDOWN region” may be computed based on data stored in a column of a relational database table, neither of which are named or identified in the relational database schema definition as “region.” Instead, the transformation, in some implementations, is accomplished using metadata for the target metric that allows the MQL statement containing to breakdown clause to be translated to an equivalent SQL statement that can be executed against the relational database in order to achieve the desired data transformation. As such, knowledge of the particular tables and columns of the underlying relational database schema is not needed in order to formulate an MQL statement for achieving the desired data metric-centric data transformation.

### Filter Clause

A filter clause may be used with a metric clause in a MQL statement to specify one or more filtering predicates on measures and/or dimensions that have the effect of limiting the measures that are included in a target metric calculation. In some implementations, the filter clause includes the keyword “FILTER” and a predicate expression. A filtering predicate may use an operator including, but not limited to, equals (‘=’), not equal (‘< >’), greater than (‘>’), greater than or equal to (‘>=’), less than (‘<’), less than or equal to (‘<=’), in (‘IN’), between (‘BETWEEN’), like (‘LIKE’), is null (‘IS NULL’), or is not null (‘IS NOT NULL’). A filter predicate can be enclosed in parentheses, and the keywords ‘AND’ and ‘OR’ may be used to combine filtering predicates into a new filtering predicate. If multiple filtering predicates are combined, parentheses can be used to group filtering predicates to indicate the order of evaluation. In the absence of parentheses, ‘AND’ may take precedence over ‘OR’.

While a MQL statement may include just a metric clause and a filter clause, a filter clause may be combined with a breakdown clause in a MQL statement. For example, the MQL statement“METRIC members BREAKDOWN DIM contributor type contribution_type FILTER contribution_type IN (‘like’, ‘share’, ‘message’)” may represent an inquiry about how many members contributed to a social network for each of a like, a share, and a message contribution_type.

A target filter predicate specified in a filter clause may be conceptual and need not (but can) directly identify underlying schema elements of the database schema of the multidimensional database data that is transformed into a target metric. For example, the target filter predicate “contribution_type IN (‘like’, ‘share’, ‘message’)” may be computed based on data stored in a column of a relational database table, neither of which are named or identified in the relational database schema definition as “contribution_type” or have values of ‘like’, ‘share’, or ‘message’. Instead, the transformation, in some implementations, is accomplished using metadata for the target metric that allows the MQL statement containing to filter clause to be translated to an equivalent SQL statement that can be executed against the relational database in order to achieve the desired data transformation. As such, knowledge of the particular tables and columns of the underlying relational database schema is not needed in order to formulate an MQL statement for achieving the desired data metric-centric data transformation.

### Time Clause

A time clause may be used in a metric clause in a MQL statement to constrain the measures that included in a target metric calculation to those that fall within a certain period of time according to the multidimensional data. In some implementations, the time clause includes a “TIME” keyword and a time expression. The time expression may indicate a time period. The time period may be expressed using a date(s) (e.g., specifying or indicating a year, month, and day), a time(s) (e.g., specifying or indicating an hour, minute, and second in UTC), a time with a time zone (e.g., specifying or indicating an hour, minute, and second in a specified or implied time zone), a timestamp(s) having a date portion and a time portion (e.g., specifying or indicating a date according to the Gregorian calendar for the date portion and a time in UTC for the time portion), or a timestamp(s) with a time zone having a date portion and a time portion (e.g., specifying or indicating a date according to the Gregorian calendar for the date portion and a time in a specified or implied time zone for the time portion). If only a single date, time, or timestamp is specified, then the time period may be relative to a current time.

For example, the example MQL statement “METRIC members BREAKDOWN DIM contributor type contribution_type FILTER contribution_type IN (‘like’, ‘share’, ‘message’) TIME 7” may represent an inquiry about how many members contributed to a social network for each of a like, a share, and a message contribution type in the past seven days. Here, days, as opposed to seconds, weeks, months, or other period of time, is implied. However, a time clause may also explicitly specify a period of time qualifier using a keyword such as “DAYS,” “MINUTES,” “MONTHS,” etc.

### System Architecture and MQL Engine

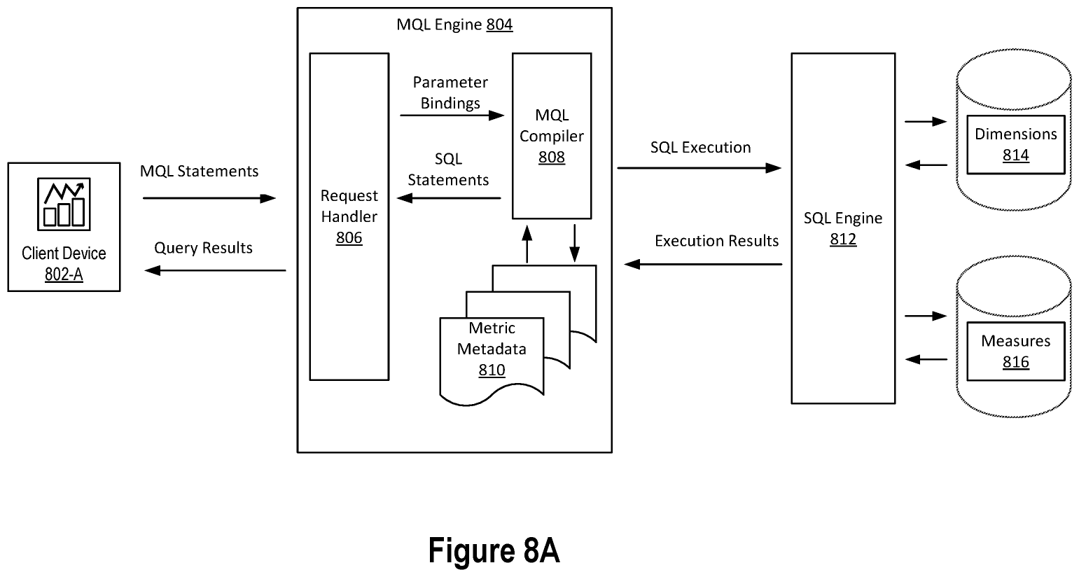

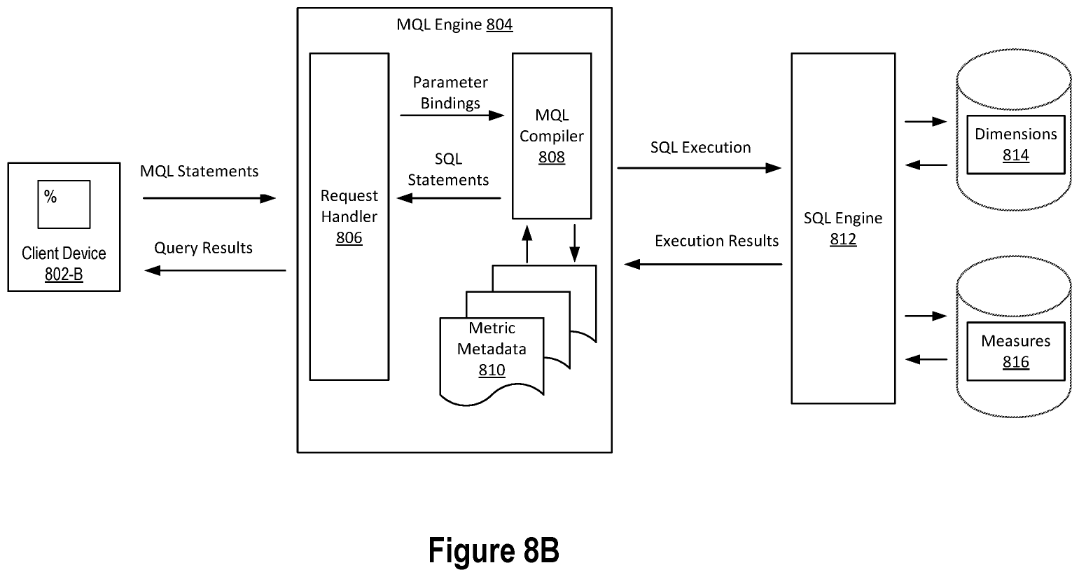

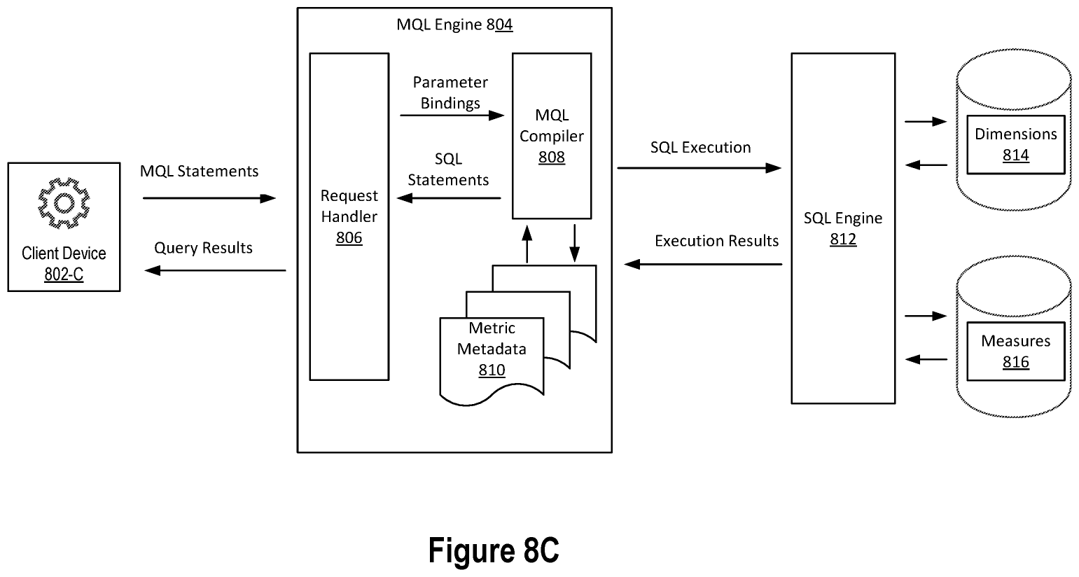

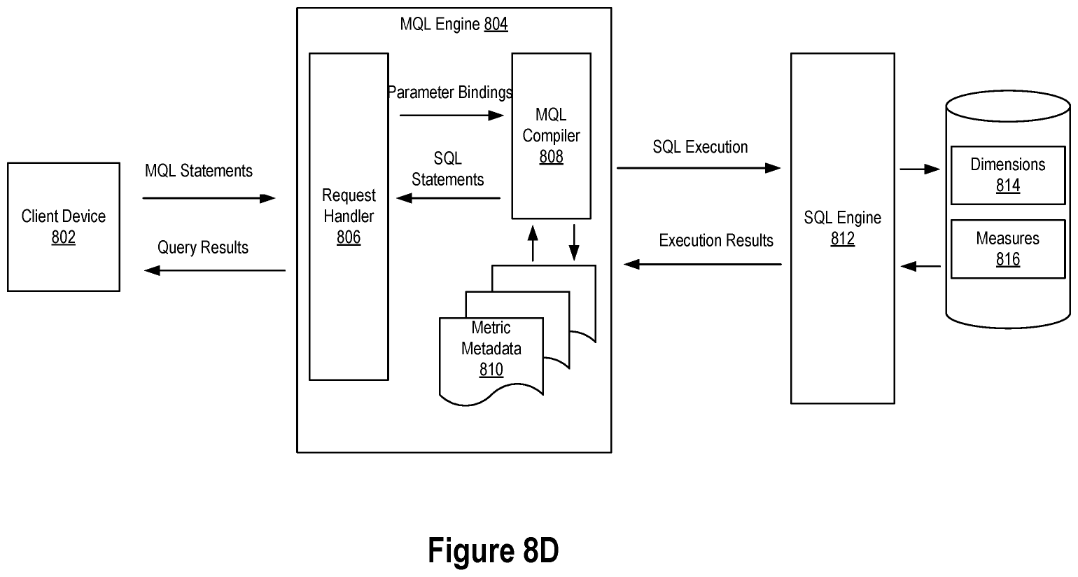

FIG. 8A illustrates a representative system architecture with a MQL engine 804. The MQL engine 804 processes an MQL statement received from a client device 802 (e.g., including a client application and an optional user interface) to transform the MQL statement to an equivalent SQL statement, and sends the SQL statement to a SQL engine 812 for execution against multidimensional database data that includes measures 816 and dimensions 814.

In some implementations, MQL is used to define metric-centric inquiries in the form of MQL statements and the MQL statements are compiled into equivalent SQL statements which can be executed by the SQL engine 812. MQL helps MQL statement authors focus on the specifics of the metric-centric inquiry and to not concern themselves with the problem of generating SQL.

While the syntax of MQL may be similar in some respects to SQL, there are important differences. In particular, MQL uses information specified in metric metadata 810 to automatically aggregate data in underlying columns, thereby making it easier to express metric-centric transformations involving aggregations. In addition, information in the metric metadata 810 may be used to automatically join measures 816 with dimensions 814, thereby simplifying the task of expressing metric-centric transformation involving joins.

In some implementations, MQL is structured as a collection of metric metadata definitions 810. In order to actually generate SQL, the MQL compiler 808 requires at least one metric metadata definition 210 be specified as an entry point, along with parameters bindings for that definition. FIG. 8A illustrates the role of the MQL compiler 808 in the MQL engine 804. When the MQL engine 804 receives a MQL statement from a client 202, a request handler 806 first translate the MQL statement into parameter bindings to pass to the MQL compiler 808, which returns a generated SQL statement. The request handler 806 then has the SQL statement executed by the SQL engine 812 against the multidimensional data that includes the measures 8216 and dimensions 814 and forwards the results back to the client 802, optionally with some pre-processing of the results before forwarding (e.g., limiting ordered results to the top N number).

In FIG. 8A, the client 802-A is a graphical user interface-based client where the MQL statement is sent from the client 802-A to the MQL engine 804 based on user input directed to the graphical user interface. However, command line clients 802-B (FIG. 8B) and autonomously operating clients 802-C (FIG. 8C) are also possible.

While measures 816 and dimensions 814 may be stored and managed by separate database systems as shown in FIG. 8A, FIG. 8B, and FIG. 8C, they may also be stored and managed in the same database system as shown in FIG. 8D. In either case, there is a SQL engine 812 that provides a SQL interface for querying the measures 816 and dimensions 814 of the multidimensional database data.

MQL is a query language for specifying data transformations. In some implementations, the MQL compiler 808 automatically determines how to aggregate query results. In addition, in some implementations, the MQL compiler 808 automatically determines how to join measures 816 with dimensions 814. Automatic aggregation and automatic joins simplify the specification of MQL statements for client applications.

To take advantage of automatic aggregation, the metric metadata 810 may optionally specify columns of tables of measures 816 and/or columns of tables of dimensions that are aggregable. For each such aggregable columns, the metric metadata 810 may specify, in the context of a target metric, an aggregation operation to perform on values in the aggregable columns (e.g., SUM, COUNT, etc.). When an MQL statement referencing a target metric is processed, the aggregable column associated with the target metric in the metric metadata 810 is implicitly aggregated for selected rows, based on the associated aggregation function.

For example, the metric metadata 810 for a target metric “sales” may be associated with an aggregable column “amount” of a sales table 302B of the multidimensional data 800A of FIG. 8B and the SUM aggregation function. When an MQL statement references a target metric in its metric clause, the MQL compiler 808 can automatically generate a SQL statement that applies the associated aggregation function to the associated aggregable column. For example, the MQL compiler 808 may generate the SQL statement “SELECT SUM (sales.amount) from sales” given the MQL statement “METRIC sales” and the metric metadata 810 for the target metric “sales.”

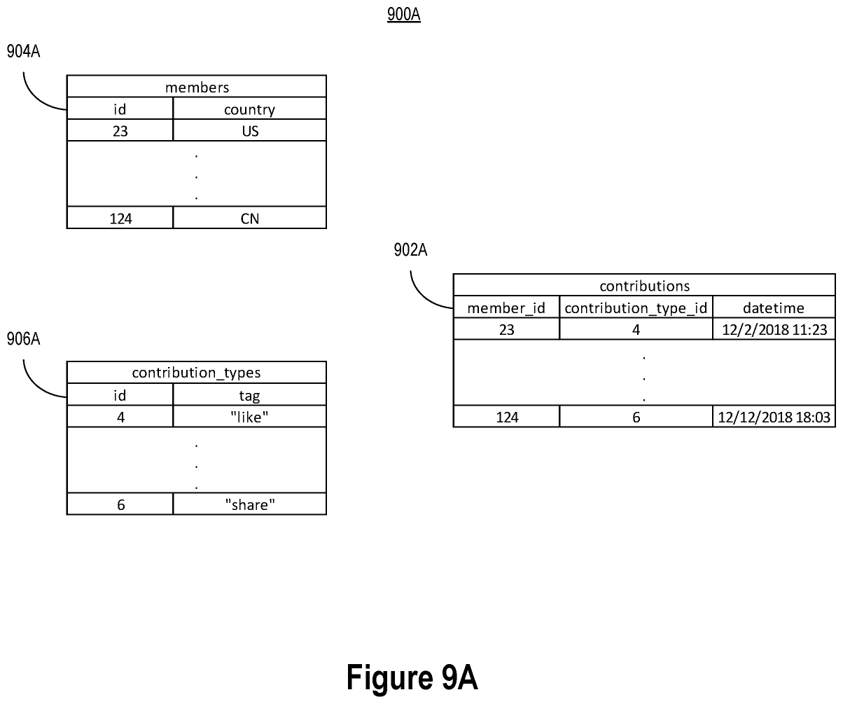

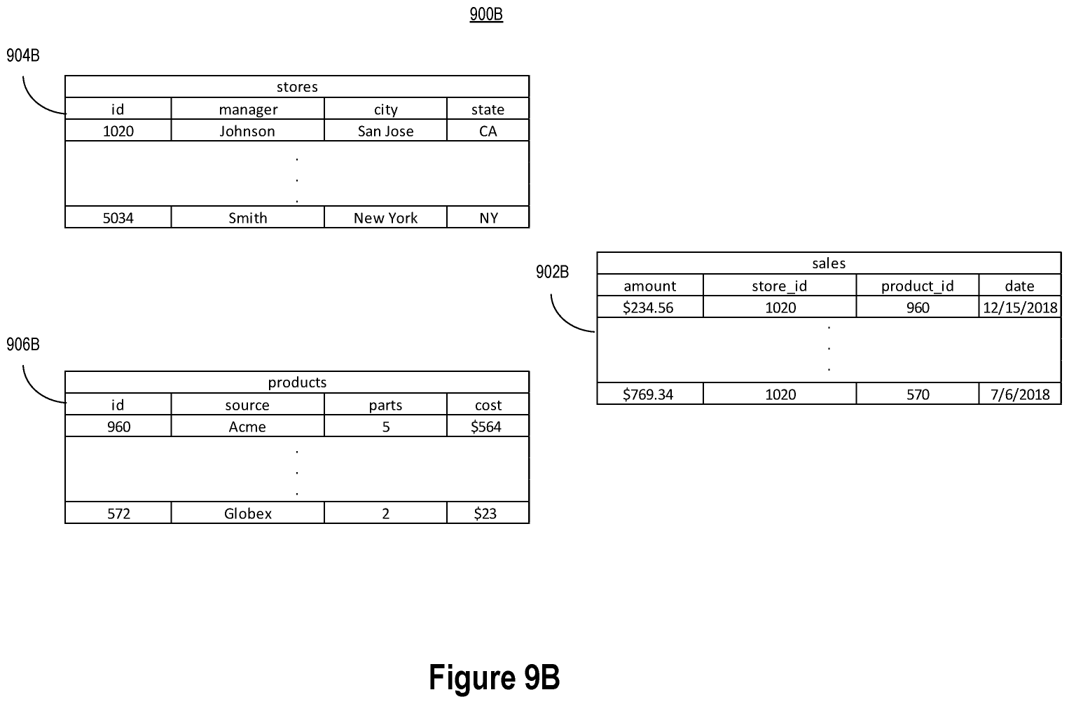

To take advantage of automation joins, the metric metadata 810 for a target metric may specify a foreign key column of a measures 816 table and a dimension key column of a dimensions 814 table. The foreign key column and the dimension key column may be used in a join in a SQL statement generated for an MQL statement that requires the join. For example, the MQL statement “METRIC members BREAKDOWN DIM contribution_type FILTER contribution_type IN (‘like’, ‘share’, ‘message’)” when intended to be evaluated against the multidimensional data 900A depicted in FIG. 9A requires a join between the contributions table 902A and the contribution_types tables 906A. The join is needed to fulfill the breakdown clause and the filter clause. For example, the following SQL statement may be generated by the MQL compiler 808 for this MQL statement: “SELECT COUNT (*) FROM contributions LEFT OUTER JOIN contribution_types ON contributions.contribution_type_id=contribution_types.id WHERE contribution_types.tag in (‘like’,‘share’,‘message’) GROUP BY contribution_types.id”

### Example Multidimensional Data

FIG. 9A depicts example multidimensional data 900A having a measures 816 table 902A named “contributions” and two dimension 814 tables 904A and 904B named “members” and “contribution_types,” respectively.

FIG. 9B depicts example multidimensional data 900B having a measure 816 table 902B named “sales” and two dimension 814 tables 904B and 906B named “stores” and “products,” respectively.

### Example Process for Metric-Centric Transformation of Multidimensional Database Data

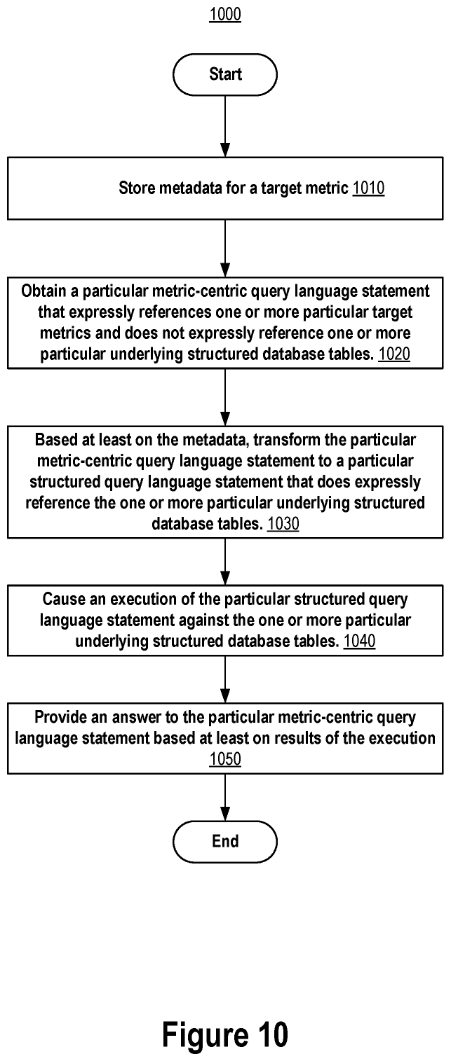

FIG. 10 is a flowchart of an example process 1000 for metric-centric transformation of multidimensional database data, according to some implementations.

Process 1000 begins by storing (1010) and maintaining metadata (e.g., 810) for target metrics. The metadata may include such information as names or monikers for the target metrics that may be used within MQL statements to reference the target metrics. In addition, the metadata for a target metric may include information about the dimensions by which the target metric can be broken down and references in a breakdown clause of a MQL statement that includes a metric clause that references the target metric. In addition, the metadata for a target metric may include information about the filters that can be used with the target metric. More generally, the metadata stored for a target metric may contain information that constrains the set of dimensions referenced in a breakdown clause to those that are compatible with the target metric when referenced together in the same MQL statement. Similarly, the metadata stored for a target metric may contain information that contains the set of filters referenced in a filter clause to those that are compatible with the target metric when referenced together in the same MQL statement. Here, compatibility may be defined in terms of the ability to form a valid SQL statement that can be successfully executed against the multidimensional database data at hand to obtain the target metric broken down and/or filtered according to the compatible breakdown clause and/or filter clause. Metadata for a target metric may also contain other information such as aggregation operation information (e.g., SUM, COUNT, AVG, etc.) for generating a SQL statement that includes the aggregation operation. The other information may also include foreign key column identifiers and dimension key columns identifiers for generating SQL statements that include the appropriate joins between measures (e.g., 816) and dimensions (e.g., 814) of the multidimensional database data.

Next, at operation 1020, an MQL statement is received by the MQL engine 804. The MQL statement may reference one or more target metrics and may not expressly reference one or more underlying database tables containing the multidimensional database data. For example, the MQL statement may not expressly reference a table or tables containing measures (e.g., 816) or dimensions (e.g., 814). In this, the MQL statement can be formulated and submitted to the MQL engine 804 without requiring knowledge of or access to the underlying database schema and the names of columns and tables containing the multidimensional database data, thereby making the MQL statement more metric-centric that an equivalent SQL statement.

Next, at operation 1030, the MQL statement received 1002 is transformed to an equivalent SQL statement 1020 based on the metadata stored 1010 for the target metric or target metrics specified in the MQL statement. Such transformation may include generating a SQL statement that includes an aggregation operation implied by the target metric(s) specified and/or a join implied by any breakdowns or filters specified in the MQL statement. Unlike the MQL statement, the generated MQL statement may expressly reference underlying database tables and columns containing the multidimensional database data including tables and columns containing measures (e.g., 1016) and dimensions (e.g., 1014).

Next, at operation 1040, the MQL engine 804 causes an execution of the generated SQL statement by the SQL engine 812 against the multidimensional database data (e.g., measures 816 and dimensions 814) including the underlying database tables expressly referenced in the SQL statement.

Finally, at operation 1050, the results obtained from the execution of the SQL statement by the SQL engine 812 are provided to the client 802.

### Example Process for Online Analytic Processing Supporting Natural Language Analytic Questions

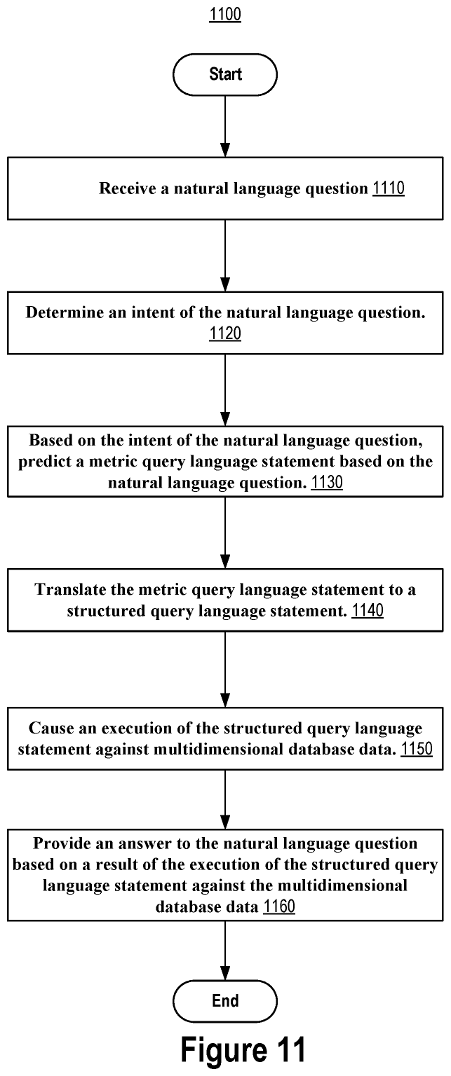

FIG. 11 is a flowchart of a process 1100 for online analytic processing supporting natural language analytic questions, according to some implementations.

At operation 1110, a natural language questions received. For example, a natural language question such as “What are the top 5 countries by the number of contributors?” may be received.

At operation 1120, an intent of the natural language question received 1110 is determined according to a trained intent classifier. For example, the intent determined could be one of: an analytic question, a metric definition question, or a different intent. For example, the trained classifier may determine the intent of the question “What are the top 5 countries by the number of contributors in the past seven days?” as an analytic question.

At operation 1130, a metric query language statement is predicted from the natural language question received 110 according to a slot-based prediction approach, based on the intent being determined 1120 as an analytic question. For example, the metric query language statement “METRIC unique_contributors TIME 7 BREAKDOWN DIM country TOP 5” may be predicted from the natural language question “What are the top 5 countries by the number of contributors in the past seven days?”.

At operation 1140, the metric query language statement predicted 1130 is translated to a structured query language statement 1140 according to metric metadata. For example, the metric query language statement “METRIC unique_contributors TIME 7 BREAKDOWN DIM country TOP 5” may be translated to the structured query language statement “Select approx_distinct(a.id) as the_most_contributors, b.country_sk as countries FROM u_metrics.flagship_active_community_contributor_union a INNER JOIN dwh_dim_column.dim_member b ON a.id=b.member_id WHERE a.datepartition>=daysago(8) GROUP BY b.country_sk ORDER BY approx_distinct(a.id) DESC.”

Next, the structured query language statement is caused 1150 to be executed against the underlying multidimensional database data and an answer to natural language question received 1110 is provided 1160 based on a result of the SQL statement execution.

### Example Process for Predicting a Metric Query Language Statement from a Natural Language Analytic Question

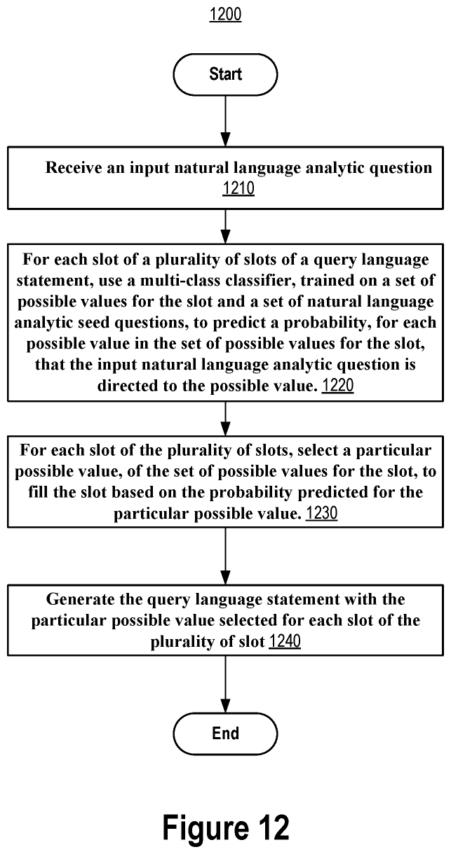

FIG. 12 is a flowchart of a process 1200 for predicting a metric query language statement from a natural language analytic question, according to some implementations.

At operation 1210, a natural language analytic question is received. For example, a natural language analytic question such as “What are the top 5 countries by the number of contributors?” may be received.

At operation 1220, for each slot of a plurality of slots of a metric query language statement template, a multi-class classifier, trained on a set of possible values for the slot and a set of natural language analytic seed questions, is used to predict a probability, for each possible value in the set of possible values for the slot, that the natural language analytic question received 1210 is directed to the possible slot value. For example, the plurality of slots may include the metric slot, the breakdown slot, and the filter slot. A metric slot model may be trained as a multi-class classifier based on a set of natural language analytic seed questions and a set of predefined possible slot values for the metric slot. A breakdown slot model may be trained as a multi-class classifier based on the set of natural language analytic seed questions and a set of predefined possible slot values for the breakdown slot. A filter slot model may be trained as a multi-class classifier based on the set of natural language analytic seed questions and a set of predefined possible slot values for the filter slot. The metric slot model may be used to predict, for each possible metric slot value, a probability that the natural language analytic question received 1210 is directed to that metric slot value. The breakdown slot model may be used to predict, for each possible breakdown slot value, a probability that the natural language analytic question received 1210 is directed to that breakdown slot value. The filter slot model may be used to predict, for each possible filter slot value, a probability that the natural language analytic question received 1210 is directed to that filter slot value.

At operation 1230, for each slot of the plurality of slots, a particular possible value, of the set of possible values for the slot, is selected to fill the slot. The selection may be based on the probability predicted 1220 for the particular possible value. For example, the possible metric slot value with the greatest probability predicted 1220 may be selected to fill the metric slot, the possible breakdown slot value with the greatest probability predicted 1220 may be selected to fill the breakdown slot, and the possible filter slot value with the greatest probability predicted 1220 may be selected to fill the filter slot.

At operation 1240, a metric query language statement with the particular possible values selected 1230 is generated. For example, if the possible metric value “unique_contributors” and the possible breakdown value “country TOP 5” is predicted, then the metric query language statement “METRIC unique_contributors BREAKDOWN DIM country TOP 5” may be generated. Note that in this example, a non-null value for the filter slot was not predicted and a non-null value for the time slot was not predicted.

### Terminology

In the foregoing detailed description and in the appended claims, although the terms first, second, etc. are, in some instances, used herein to describe various elements, these elements should not be limited by these terms. These terms are only used to distinguish one element from another. For example, a first user interface could be termed a second user interface, and, similarly, a second user interface could be termed a first user interface, without departing from the scope of the various described implementations. The first user interface and the second user interface are both user interfaces, but they are not the same user interface.

The terminology used in the foregoing detailed description and in the appended claims of the various described implementations herein is for the purpose of describing particular implementations only and is not intended to be limiting. As used in the foregoing detailed description and in the appended claims of the various described implementations, the singular forms “a,” “an,” and “the” are intended to include the plural forms as well, unless the context clearly indicates otherwise. It will also be understood that the term “and/or” as used in the foregoing detailed description and in the appended claims refers to and encompasses any and all possible combinations of one or more of the associated listed items. It will be further understood that the terms “includes,” “including,” “comprises,” and/or “comprising,” when used in the foregoing detailed description and in the appended claims, specify the presence of stated features, integers, steps, operations, elements, and/or components, but do not preclude the presence or addition of one or more other features, integers, steps, operations, elements, components, and/or groups thereof.

As used in the foregoing detailed description and in the appended claims, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

For situations in which implementations discussed above collect information about users, the users may be provided with an opportunity to opt in/out of programs or features that may collect personal information. In addition, in some implementations, certain data may be anonymized in one or more ways before it is stored or used, so that personally identifiable information is removed. For example, a user's identity may be anonymized so that the personally identifiable information cannot be determined for or associated with the user, and so that user preferences or user interactions are generalized (for example, generalized based on user demographics) rather than associated with a particular user.

### Extensions and Alternatives

Although some of various drawings illustrate a number of logical stages in a particular order, stages that are not order dependent may be reordered and other stages may be combined or broken out. While some reordering or other groupings are specifically mentioned, others will be obvious to those of ordinary skill in the art, so the ordering and groupings presented herein are not an exhaustive list of alternatives. Moreover, it should be recognized that the stages could be implemented in hardware, firmware, software or any combination thereof.

The foregoing description, for purpose of explanation, has been described with reference to specific implementations. However, the illustrative discussions above are not intended to be exhaustive or to limit the scope of the claims to the precise forms disclosed. Many modifications and variations are possible in view of the above teachings. The implementations were chosen in order to best explain the principles underlying the claims and their practical applications, to thereby enable others skilled in the art to best use the implementations with various modifications as are suited to the particular uses contemplated.

1. A method performed by a computing system having one or more processors and storage media, the storage media storing instructions configured to perform the method, the instructions executed by the one or more processors to perform the method, the method comprising:
receiving a natural language question;
determining an intent of the natural language question;
based on the intent of the natural language question, predicting a metric query language statement based on the natural language question;
translating the metric query language statement to a structured query language statement;
causing an execution of the structured query language statement against multidimensional database data; and
providing an answer to the natural language question based on a result of the execution of the structured query language statement against the multidimensional database data.

2. The method of claim 1, wherein the determining the intent of the natural language question is based on training an intent classifier; and wherein the determining the intent of the natural language question is based on classifying the natural language question using the trained intent classifier.

3. The method of claim 2, wherein the intent of the natural language question determined is a natural language analytic question.

4. The method of claim 1, wherein the predicting the metric query language statement is based on predicting a value for each slot of a plurality of metric query language statement slots using a trained multi-class classifier model.

5. The method of claim 4, wherein the plurality of metric query language statement slots includes a metric slot, a breakdown slot, and a filter slot.

6. The method of claim 1, wherein the predicting the metric query language statements is based on:
for each slot of a plurality of metric query language statement slots, using a multi-class classifier model to predict a probability that the natural language question is directed to a particular possible value for the slot of a predefined set of possible values for the slot;
for each slot of the plurality of metric query language statement slots, selecting the particular possible value for the slot, from the predefined set of possible values for the slot, to fill the slot based on the probability predicted that the natural language question is directed to the particular possible value for the slot; and
generating the metric query language statement based on the particular possible value selected for each slot of the plurality of metric query language statement slots.

7. The method of claim 1, wherein:
the translating the metric query language statement to a structured query language statement is based on metadata for a target metric referenced by the metric query language statement;
the metadata for the target metric specifies an implied aggregation operation;
the metric query language statement does not expressly reference the implied aggregation operation; and
the structured query language statement does expressly reference the implied aggregation operation.

8. One or more non-transitory computer-readable media comprising:
one or more programs having instructions for execution by a computing system having one or more processors, the instructions configured for:
receiving a natural language question;
determining an intent of the natural language question;
based on the intent of the natural language question, predicting a metric query language statement based on the natural language question;
translating the metric query language statement to a structured query language statement;
causing an execution of the structured query language statement against multidimensional database data; and
providing an answer to the natural language question based on a result of the execution of the structured query language statement against the multidimensional database data.

9. The one or more non-transitory computer-readable of claim 8, wherein the determining the intent of the natural language question is based on training an intent classifier; and wherein the determining the intent of the natural language question is based on classifying the natural language question using the trained intent classifier.

10. The one or more non-transitory computer-readable of claim 9, wherein the intent of the natural language question determined is a natural language analytic question.

11. The one or more non-transitory computer-readable of claim 8, wherein the predicting the metric query language statement is based on predicting a value for each slot of a plurality of metric query language statement slots using a trained multi-class classifier model.

12. The one or more non-transitory computer-readable of claim 11, wherein the plurality of metric query language statement slots includes a metric slot, a breakdown slot, and a filter slot.

13. The one or more non-transitory computer-readable of claim 8, wherein the predicting the metric query language statements is based on:
for each slot of a plurality of metric query language statement slots, using a multi-class classifier model to predict a probability that the natural language question is directed to a particular possible value for the slot of a predefined set of possible values for the slot;
for each slot of the plurality of metric query language statement slots, selecting the particular possible value for the slot, from the predefined set of possible values for the slot, to fill the slot based on the probability predicted that the natural language question is directed to the particular possible value for the slot; and
generating the metric query language statement based on the particular possible value selected for each slot of the plurality of metric query language statement slots.

14. The one or more non-transitory computer-readable of claim 8, wherein:
the translating the metric query language statement to a structured query language statement is based on metadata for a target metric referenced by the metric query language statement;
the metadata for the target metric specifies an implied aggregation operation;
the metric query language statement does not expressly reference the implied aggregation operation; and
the structured query language statement does expressly reference the implied aggregation operation.

15. A computing system comprising:
one or more processors;
storage media;
one or more programs stored in the storage media and having instructions for execution by the one or more processors, the instructions configured for:
receiving a natural language question;
determining an intent of the natural language question;
based on the intent of the natural language question, predicting a metric query language statement based on the natural language question;
translating the metric query language statement to a structured query language statement;
causing an execution of the structured query language statement against multidimensional database data; and
providing an answer to the natural language question based on a result of the execution of the structured query language statement against the multidimensional database data.

16. The computing system of claim 15, wherein the determining the intent of the natural language question is based on training an intent classifier; and wherein the determining the intent of the natural language question is based on classifying the natural language question using the trained intent classifier.

17. The computing system of claim 16, wherein the intent of the natural language question determined is a natural language analytic question.

18. The computing system of claim 15, wherein the predicting the metric query language statement is based on predicting a value for each slot of a plurality of metric query language statement slots using a trained multi-class classifier model.

19. The computing system of claim 15, wherein the predicting the metric query language statements is based on:
for each slot of a plurality of metric query language statement slots, using a multi-class classifier model to predict a probability that the natural language question is directed to a particular possible value for the slot of a predefined set of possible values for the slot;
for each slot of the plurality of metric query language statement slots, selecting the particular possible value for the slot, from the predefined set of possible values for the slot, to fill the slot based on the probability predicted that the natural language question is directed to the particular possible value for the slot; and
generating the metric query language statement based on the particular possible value selected for each slot of the plurality of metric query language statement slots.

20. The computing system of claim 15, wherein:
the translating the metric query language statement to a structured query language statement is based on metadata for a target metric referenced by the metric query language statement;
the metadata for the target metric specifies an implied aggregation operation;
the metric query language statement does not expressly reference the implied aggregation operation; and
the structured query language statement does expressly reference the implied aggregation operation.
